(19) United States
(12) Patent Application Publication
(10) Pub. No.: US 2013/0077885 A1
(43) Pub. Date: Mar. 28, 2013

(54) IMAGE CODING APPARATUS AND IMAGE CODING METHOD, AND IMAGE DECODING APPARATUS AND IMAGE DECODING METHOD

(71) Applicants: Peng Wang, Tokyo (JP); Kazushi Sato, Kanagawa (JP)

(72) Inventors: Peng Wang, Tokyo (JP); Kazushi Sato, Kanagawa (JP)

(21) Appl. No.: 13/638,654

(22) PCT Filed: Mar. 30, 2011
(86) PCT No.: PCT/JP2011/057998

§ 371 Date: Dec. 13, 2012

(30) Foreign Application Priority Data
Apr. 9, 2010 (JP) 2010-090334

(51) Int. Cl. G06K 9/36

(52) U.S. Cl. CPC G06K 9/36
USPC 382/238

(57) ABSTRACT

The data amount of coding data is to be reduced by using a larger block.

An edge LMB determination unit 34 determines an edge block having a size smaller than a block size of a set block. An LMB motion prediction and compensation unit 35 determines a coding efficiency at a prediction block size corresponding to a size of a non-square region determined as the edge block or a prediction block size corresponding to a size of plural non-square regions obtained by dividing the region determined as the edge block in one of directions of a horizontal direction and a vertical direction with respect to the edge block to generate prediction image data at the prediction block size at which the coding efficiency becomes highest. With respect to the edge block, a prediction block size of a macro block at a lower level having a small size is used, and it is possible to avoid the division of the edge block into a large number of blocks to be coded, so that the data amount of the coding data can be reduced.

### TECHNICAL FIELD

This invention relates to an image coding apparatus and an image coding method, and an image decoding apparatus and an image decoding method. In detail, the data amount of coding data is to be reduced by using a larger block.

### BACKGROUND ART

In recent years, an apparatus configured to digitally treat image information and perform a highly efficient transmission and accumulation of the information at that time such as, for example, an apparatus in conformity to a system like MPEG for carrying out a compression by way of an orthogonal transform such as a discrete cosine transform and a motion compensation is being widespread to a broadcasting station and a general household.

In particular, MPEG2 (ISO/IEC13818-2) is defined as a general-purpose image coding system and currently widely used for extensive applications for a professional use and a consumer use. By using this MPEG2 compression system, for example, in the case of an interlace scanning image of a standard resolution having 720×480 pixels, it is possible to realize a satisfactory image quality by allocating a code amount (bit rate) of 4 to 8 Mbps. Also, in the case of an interlace scanning image of a high resolution having 1920×1088 pixels, it is possible to realize a satisfactory image quality by allocating a code amount (bit rate) of 18 to 22 Mbps.

MPEG2 mainly targets a high image quality coding adapted to a broadcasting use but does not correspond to a code amount (bit rate) lower than MPEG1, to elaborate, a coding system at a higher compression rate. Along with the widespread of mobile terminals, needs for the above-mentioned coding system are expected to be increased in the future, and while corresponding to this, a standardization of the MPEG4 coding system is carried out. With regard to the image coding system, a specification thereof is approved as ISO/IEC14496-2 for an international standard in December, 1998.

Furthermore, in recent years, with an aim of an image coding for a television conference use at first, a normalization for a standard called H.26L (ITU-T Q6/16 VCEG) is advanced. As compared with the coding system in related art such as MPEG2 or MPEG4, H.26L demands more computation amounts for the coding and decoding, but it is known that a higher coding efficiency is realized. Also, currently, as a field of activities for MPEG4, while this H.26L is used as a base, a standardization for realizing a higher coding efficiency is carried out as Joint Model of Enhanced-Compression Video Coding. For a schedule of the standardizations, in March, 2003, international standardizations are established under the names of H.264 and MPEG-4 Part10 (Advanced Video Coding, and hereinafter, which will be referred to as “H.264/AVC”).

Furthermore, as an expansion thereof, a standardization of FRExt (Fidelity Range Extension) including coding tools necessary for an institutional use such as RGB, 4:2:2, and 4:4:4 and also 8×8 DCT and a quantization matrix prescribed in MPEG2 is completed in February, 2005. According to this, with use of the H.264/AVC system, the system becomes a coding system with which even a film noise included in a movie can also be satisfactorily represented and is expected to be used for extensive applications such as Blu-Ray™.

Also, nowadays, needs for a coding at a still higher compression rate are increased in which an image of approximately 4000×2000 pixels is desired to be compressed or a high vision image is desired to be distributed in an environment where a transmission capacity is limited like the internet. For this reason, as in NPL 1, a conduction of an intra prediction is proposed while a macro block side is set to have a size of 32 pixels×32 pixels, for example, which is larger than MPEG2 or H.264/AVC. Also, as in NPL 2, a conduction of an inter prediction is proposed while a macro block side is set to have a size of 32 pixels×32 pixels, for example, which is larger than MPEG2 or H.264/AVC.

That is, according to NPL 1 and 2, by adopting a hierarchical structure with respect to the macro block, with regard to a block of 16×16 pixels or smaller, a compatibility with the macro block in H.264/AVC is maintained, and a still larger block is defined as a super set thereof.

### CITATION LIST

### Non Patent Literature

NPL 1: Sung-Chang Lim, Hahyun Lee, Jinho Lee, Jongho Kim, Haechul Choi, Seyoon Jeong, Jin Soo Choi “Intra coding using extended block size” (ITU-Telecommunications Standardization Sector, Study Group16 Question6, Video Coding Experts Group, 38th Meeting: London, UK/Geneva, CH, 1-8 July, 2009, D)
NPL 2: Qualcomm Inc “Video Coding Using Extended Blockl Sizes” (STUDY GROUP16-CONTRIBUTION 123, ITU-Telecommunications Standardization Sector, January, 2009)

### SUMMARY OF INVENTION

### Technical Problem

Incidentally, in a case where a macro block with an expanded size is used, depending on the numbers of pixels in a horizontal direction and a vertical direction of a frame image, a case may occur in which a region that does not fulfill the macro block size of the expanded scale is generated on an edge part side of the image. If the coding is carried out at the macro block size before the expansion in this region that does not fulfill the macro block size of the expanded scale, the number of blocks is increased, and it becomes difficult to reduce the data amount of the coding data.

In view of the above, according to this invention, it aims to provide an image coding apparatus and an image coding method, and an image decoding apparatus and an image decoding method with which the data amount of coding data can be reduced by using a larger block.

### Solution to Problem

A first aspect of this invention resides in an image coding apparatus that performs a coding processing on image data, the apparatus including: an edge block determination unit configured to determine, in a case where a block is set with respect to an image of a coding target, an edge block having a size smaller than a block size of the block; a prediction processing unit configured to detect, while a region determined as the edge block by the edge block determination unit is set as a target, a prediction block size corresponding to a size of the region determined as the edge block or a prediction block size corresponding to a size of plural non-square regions obtained by dividing the region determined as the edge block in one of directions of a horizontal direction and a vertical direction; and a coding unit configured to code the image data and prediction mode information related to the prediction processing on the prediction block size detected by the prediction processing unit to generate a coding stream.

According to this invention, in a case where a block larger than a predetermined size is set with respect to the image of the coding target, the determination on the edge block having a smaller size than the block size of this block is carried out for each frame or each slice. While a non-square region determined as this edge block, for example, is set as a target, a coding efficiency is determined at the prediction block size corresponding to the size of the region determined as the edge block or the prediction block size corresponding to the size of the plural non-square regions obtained by dividing the region determined as the edge block in one of the directions of the horizontal direction and the vertical direction, and the coding is carried out at the prediction block size at which the coding efficiency is increased. Also, with regard to the square region determined as the edge block and the square region generated after the division, the determination on the coding efficiency is carried out by using the prediction block size set for the block at a lower level having a size smaller than the block. Furthermore, the image data on which the coding processing is carried out and the prediction mode information related to the prediction processing on the prediction block size at which the coding efficiency is increased are subjected to a lossless coding, and when the coding stream is to be generated, without changing a syntax element depending on whether or not the block is the edge block, the coding stream is generated.

A second aspect of this invention resides in an image coding method of performing a coding processing on image data, the method including the steps of: determining, in a case where a block is set with respect to an image of a coding target, an edge block having a size smaller than a block size of the block; detecting, while a region determined as the edge block is set as a target, a prediction block size corresponding to a size of the region determined as the edge block or a prediction block size corresponding to a size of plural non-square regions obtained by dividing the region determined as the edge block in one of the directions of the horizontal direction and the vertical direction; and coding the image data and prediction mode information related to the prediction processing on the detected prediction block size and generating a coding stream.

A third aspect of this invention resides in an image decoding apparatus that performs a decoding processing on a coding stream obtained by coding image data, the apparatus including: an edge block determination unit configured to determine, on the basis of an image size of a decoding target image and a position of a block on which the decoding processing is performed, an edge block having a size smaller than a block size of the block; a prediction processing unit configured to generate prediction image data used for the decoding processing on the image data at a prediction block size corresponding to a size of a region determined as the edge block or a region obtained by dividing the region determined as the edge block in one of directions of a horizontal direction and a vertical direction while a non-square region determined as the edge block is set as a target in a case where the edge block is determined by the edge block determination unit; and a decoding unit configured to decode the coding stream by using the prediction image data generated by the prediction processing unit.

According to this invention, on the basis of the image size of the decoding target image and the position of the block on which the decoding processing is performed, the determination on the edge block having a smaller size than the block size of this block is carried out for each frame or each slice. In a case where the edge block is determined, on the basis of block type information obtained through the decoding processing on the image data, while the region determined as the edge block is set as a target, the determination is made on whether the prediction block size is a size of the region determined as the edge block or a size of a region obtained by dividing the region determined as the edge block in one of the directions of the horizontal direction and the vertical direction, and the prediction image data used for the decoding processing on the image data is generated at the determined prediction block size. Also, in a case where the determined edge block is a square region, on the basis of block type information obtained through the decoding processing on the image data, with regard to the square region determined as the edge block, the determination is made on whether the prediction block size is one of prediction block sizes set for blocks at a lower level having a size smaller than the block, and the prediction image data used for the decoding processing on the image data is generated at the determined prediction block size. Also, in the image decoding apparatus, by switching meanings thereof (semantics) in a syntax element indicating the prediction block size included in the coding stream in accordance with the determination result on the edge block, the determination on the prediction block sizes in the block and the edge block is carried out.

A fourth aspect of this invention resides in image decoding method of performing a decoding processing on a coding stream obtained by coding image data, the method including the steps of: determining, on the basis of an image size of a decoding target image and a position of a block on which the decoding processing is performed, an edge block having a size smaller than a block size of the block; generating prediction image data used for the decoding processing on the image data at a prediction block size corresponding to a size of a region determined as the edge block or a region obtained by dividing the region determined as the edge block in one of directions of a horizontal direction and a vertical direction while a non-square region determined as the edge block is set as a target in a case where the edge block is determined; and decoding the coding stream by using the generated prediction image data.

### Advantageous Effects of Invention

According to this invention, with regard to the edge block having a size smaller than the block size of the block subjected to the coding processing or the decoding processing, the coding efficiency is determined at the prediction block size corresponding to the size of the region determined as the edge block and the prediction block size corresponding to the size of the plural non-square regions obtained by dividing the region determined as the edge block in one of the directions of the horizontal direction and the vertical direction, and the coding or decoding of the image is carried out at the prediction block size at which the coding efficiency is increased. For this reason, with regard to the edge block, the prediction block size of the block at the lower level having the small size is used, and the division of the edge block into a large number of block to be coded is avoided, so that the data amount of the coding data can be reduced by using a larger block.

### BRIEF DESCRIPTION OF DRAWINGS

FIG. 1 illustrates a configuration of an image coding apparatus.

FIG. 2 illustrates a configuration of an LMB motion prediction and compensation unit.

FIG. 3 illustrates a prediction block size (motion compensation block size).

FIG. 4 is an explanatory diagram for describing an edge block.

FIG. 5 exemplifies a case in which a macro block in related art is set with regard to the edge block.

FIG. 6 is an explanatory diagram for describing a case in which a macro block is 32×32 pixels.

FIG. 7 illustrates the edge block at a time when the macro block is set as 64×64 pixels.

FIG. 8 is an explanatory diagram for describing a case in which the macro block is 64×64 pixels.

FIG. 9 is an explanatory diagram for describing another case in which the macro block is 64×64 pixels.

FIG. 10 illustrates examples of CU defined in an HEVC coding system.

FIG. 11 is a flow chart illustrating an image coding processing operation.

FIG. 12 is a flow chart illustrating a prediction processing.

FIG. 13 is a flow chart illustrating an intra prediction processing.

FIG. 14 is a flow chart illustrating an inter prediction processing.

FIG. 15 is a flow chart illustrating an LMB inter prediction processing.

FIG. 16 illustrates a configuration of an image decoding apparatus.

FIG. 17 illustrates a configuration of the LMB motion prediction and compensation unit.

FIG. 18 is a flow chart illustrating an image decoding processing operation.

FIG. 19 is a flow chart illustrating the prediction processing.

FIG. 20 is a flow chart illustrating the inter prediction processing performed in the LMB motion prediction and compensation unit.

### DESCRIPTION OF EMBODIMENTS

Hereinafter, a description will be given of embodiments for carrying out the invention. It should be noted that the description will be given in the following order.

1. Configuration of image coding apparatus
2. Configuration of LMB motion prediction and compensation unit
3. Regarding block
4. Operation of image coding apparatus
5. Configuration of image decoding apparatus
6. Configuration of LMB motion prediction and compensation unit
7. Operation of image decoding apparatus

<1. Configuration of Image Coding Apparatus>

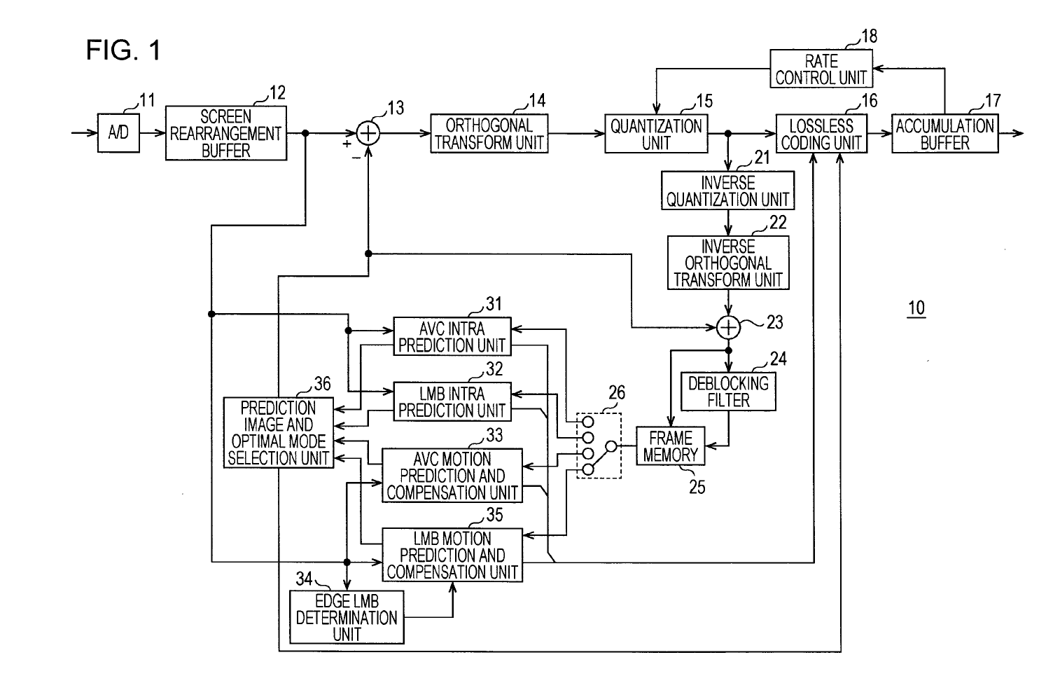

FIG. 1 illustrates a configuration of an image coding apparatus. An image coding apparatus 10 has an analog/digital conversion unit (A/D conversion unit) 11, a screen rearrangement buffer 12, a subtraction unit 13, an orthogonal transform unit 14, a quantization unit 15, a lossless coding unit 16, an accumulation buffer 17, and a rate control unit 18. Furthermore, the image coding apparatus 10 has an inverse quantization unit 21, an inverse orthogonal transform unit 22, an addition unit 23, a deblocking filter 24, a frame memory 25, a selector 26, an AVC intra prediction unit 31, an LMB intra prediction unit 32, an AVC motion prediction and compensation unit 33, an edge LMB determination unit 34, an LMB motion prediction and compensation unit 35, and a prediction image and optimal mode selection unit 36.

The A/D conversion unit 11 converts an analog image signal into digital image data to be output to the screen rearrangement buffer 12.

The screen rearrangement buffer 12 performs a rearrangement of frames with respect to the image data output from the A/D conversion unit 11. The screen rearrangement buffer 12 performs the rearrangement of the frames in accordance with a GOP (Group of Pictures) structure related to the coding processing and outputs the image data after the rearrangement to the subtraction unit 13, the AVC intra prediction unit 31, the LMB intra prediction unit 32, the AVC motion prediction and compensation unit 33, and the LMB motion prediction and compensation unit 35.

The subtraction unit 13 is supplied with the image data output from the screen rearrangement buffer 12 and prediction image data selected by the prediction image and optimal mode selection unit 36 which will be described below. The subtraction unit 13 calculates prediction error data that is a difference between the image data output from the screen rearrangement buffer 12 and the prediction image data supplied from the prediction image and optimal mode selection unit 36 to be output to the orthogonal transform unit 14.

The orthogonal transform unit 14 performs an orthogonal transform processing such as a discrete cosine transform (DCT; Discrete Cosine Transform) or Karhunen-Loeve transform on the prediction error data output from the subtraction unit 13. The orthogonal transform unit 14 outputs transform coefficient data obtained by carrying out the orthogonal transform processing to the quantization unit 15.

The quantization unit 15 is supplied with the transform coefficient data output from the orthogonal transform unit 14 and a rate control signal from the rate control unit 18 which will be described below. The quantization unit 15 performs a quantization of the transform coefficient data and outputs quantization data to the lossless coding unit 16 and the inverse quantization unit 21. Also, the quantization unit 15 switches a quantization parameter (quantization scale) on the basis of the rate control signal from the rate control unit 18 to change a bit rate of the quantization data.

The lossless coding unit 16 is supplied with the quantization data output from the quantization unit 15 and prediction mode information output from the AVC intra prediction unit 31, the LMB intra prediction unit 32, the AVC motion prediction and compensation unit 33, the LMB motion prediction and compensation unit 35, and the prediction image and optimal mode selection unit 36 which will be described below. It should be noted that the prediction mode information includes a prediction mode, a prediction block size, motion vector information, reference picture information, or the like in accordance with the intra prediction or the inter prediction.

The lossless coding unit 16 performs a lossless coding processing on the quantization data by way of, for example, a variable length coding, an arithmetic coding, or the like to generate a coding stream to be output to the accumulation buffer 17. Also, the lossless coding unit 16 subjects the prediction mode information to the lossless coding to be added to header information of the coding stream.

The accumulation buffer 17 accumulates the coding stream from the lossless coding unit 16. Also, the accumulation buffer 17 outputs the accumulated coding stream at a transmission speed in accordance with a transmission path.

The rate control unit 18 performs a monitoring on a free space of the accumulation buffer 17 and generates a rate control signal in accordance with the free space to be output to the quantization unit 15. The rate control unit 18 obtains, for example, information indicating the free space from the accumulation buffer 17. When the free space is scarce, the rate control unit 18 decreases the bit rate of the quantization data by the rate control signal. Also, when the free space of the accumulation buffer 17 is sufficiently large, the rate control unit 18 increases the bit rate of the quantization data by the rate control signal.

The inverse quantization unit 21 performs an inverse quantization on the quantization data supplied from the quantization unit 15. The inverse quantization unit 21 outputs transform coefficient data obtained by carrying out the inverse quantization to the inverse orthogonal transform unit 22.

The inverse orthogonal transform unit 22 outputs data obtained by carrying out an inverse orthogonal transform processing on the transform coefficient data supplied from the inverse quantization unit 21 to the addition unit 23.

The addition unit 23 adds the data supplied from the inverse orthogonal transform unit 22 to the prediction image data supplied from the prediction image and optimal mode selection unit 36 to generate decoding image data to be output to the deblocking filter 24 and the frame memory 25.

The deblocking filter 24 performs a filter processing for reducing a block distortion generated at the time of the coding of the image. The deblocking filter 24 performs a filter processing for removing the block distortion from the decoding image data supplied from the addition unit 23 and outputs the decoding image data to the frame memory 25.

The frame memory 25 holds the decoding image data supplied from the addition unit 23 and the decoding image data after the filter processing supplied from the deblocking filter 24.

The selector 26 supplies the decoding image data before the filter processing which is read from the frame memory 25 for performing the intra prediction to the AVC intra prediction unit 31 and the LMB intra prediction unit 32. Also, the selector 26 supplies the decoding image data after the filter processing which is read from the frame memory 25 for performing the inter prediction to the AVC motion prediction and compensation unit 33 and the LMB motion prediction and compensation unit 35.

The AVC intra prediction unit 31 performs an intra prediction processing of the respective intra prediction modes prescribed in the H.264/AVC system on the basis of the image data of the coding target image output from the screen rearrangement buffer 12 and the decoding image data supplied via the selector 26. The AVC intra prediction unit 31 calculates cost function values in the respective intra prediction modes and selects the intra prediction mode in which the calculated cost function value becomes smallest, that is, the intra prediction mode in which the coding efficiency becomes highest as an optimal intra prediction mode. Furthermore, the AVC intra prediction unit 31 outputs the prediction image data and the cost function value generated in an AVC optimal intra prediction mode and the prediction mode information to the prediction image and optimal mode selection unit 36.

The LMB intra prediction unit 32 performs the intra prediction processing at a block having a size larger than the respective intra prediction modes prescribed in the H.264/AVC system on the basis of the image data of the coding target image output from the screen rearrangement buffer 12 and the decoding image data supplied via the selector 26. The LMB intra prediction unit 32 calculates cost function values in the respective intra prediction modes and selects the intra prediction mode in which the calculated cost function value becomes smallest, that is, the intra prediction mode in which the coding efficiency becomes highest as an optimal LMB intra prediction mode. Furthermore, the LMB intra prediction unit 32 outputs the prediction image data, the cost function value, and the prediction mode information generated in the optimal LMB intra prediction mode to the prediction image and optimal mode selection unit 36. It should be noted that blocks used in the LMB intra prediction unit 32 and the LMB motion prediction and compensation unit 35 will be described below.

The AVC motion prediction and compensation unit 33 performs a motion prediction and compensation processing at the respective prediction block sizes (motion compensation block sizes) prescribed in the H.264/AVC system on the basis of the image data of the coding target image output from the screen rearrangement buffer 12 and the decoding image data supplied via the selector 26. Also, the AVC motion prediction and compensation unit 33 calculates the cost function values at the respective prediction block sizes and a prediction block size at which the calculated cost function value becomes smallest, that is, a prediction block size at which the coding efficiency becomes highest as an AVC optimal inter prediction mode. The AVC motion prediction and compensation unit 33 outputs the prediction image data, the cost function value, and the prediction mode information generated in the AVC optimal inter prediction mode to the prediction image and optimal mode selection unit 36. It should be noted that the AVC motion prediction and compensation unit 33 detects a motion vector on the basis of the image data of the coding target image read out from the screen rearrangement buffer 12 and the reference image data (decoding image data) supplied from the frame memory 25. The AVC motion prediction and compensation unit 33 applies a motion compensation processing on the reference image data on the basis of this motion vector to carry out the generation of the prediction image data.

In a case where a block is set with respect to the image of the coding target, the edge LMB determination unit 34 performs a determination on an edge block having a smaller size than the block size of this block. When a macro block is sequentially set from a position on the upper right corner of the input image, the edge LMB determination unit 34 determines a block (hereinafter, which will be referred to as “edge block”) having a size smaller than the block size of the block set by the block size at a left edge and a lower edge of the input image. The edge LMB determination unit 34 outputs the determination result on the edge block to the LMB motion prediction and compensation unit 35. The edge LMB determination unit 34 can determine the edge block having a size smaller than the block size of the block set by the block size by using, for example, the numbers of pixels in the horizontal direction and the vertical direction of the image of the coding target and address information on the sequentially set macro blocks. Also, in a case where different types of slices can be prepared in one picture, a switching of the prediction modes can be carried out not only in the frame unit but also in the slice unit. Therefore, in the above-mentioned case, the determination on the edge block is carried out not only for each frame but also for each slice.

The LMB motion prediction and compensation unit 35 performs the motion prediction and compensation processing at a time when a block having a size larger than the macro block prescribed in the H.264/AVC system is used on the basis of the image data of the coding target image output from the screen rearrangement buffer 12 and the decoding image data supplied via the selector 26. Also, the LMB motion prediction and compensation unit 35 calculates the cost function value at the respective prediction block sizes (motion compensation block sizes) and selects a prediction block size at which the calculated cost function value becomes smallest, that is, a prediction block size at which the coding efficiency becomes highest as an LMB optimal inter prediction mode. Furthermore, the LMB motion prediction and compensation unit 35 outputs the prediction image data, and the cost function value, and the prediction mode information generated in the optimal inter prediction mode to the prediction image and optimal mode selection unit 36. It should be noted that the LMB motion prediction and compensation unit 35 performs a generation of the prediction image similarly as in the AVC motion prediction and compensation unit 33.

The prediction image and optimal mode selection unit 36 compares the cost function values supplied from the AVC intra prediction unit 31, the LMB intra prediction unit 32, the AVC motion prediction and compensation unit 33, and the LMB motion prediction and compensation unit 35. The prediction image and optimal mode selection unit 36 selects a prediction mode in which the cost function value becomes lowest, that is, a prediction mode in which the coding efficiency becomes highest as an optimal mode on the basis of the comparison result of the cost function values. Also, the prediction image and optimal mode selection unit 36 outputs the prediction image data generated in the optimal mode to the subtraction unit 13 and the addition unit 23. Furthermore, the prediction image and optimal mode selection unit 36 outputs the prediction mode information in the optimal mode to the lossless coding unit 16.

<2. Configuration of LMB Motion Prediction and Compensation Unit>

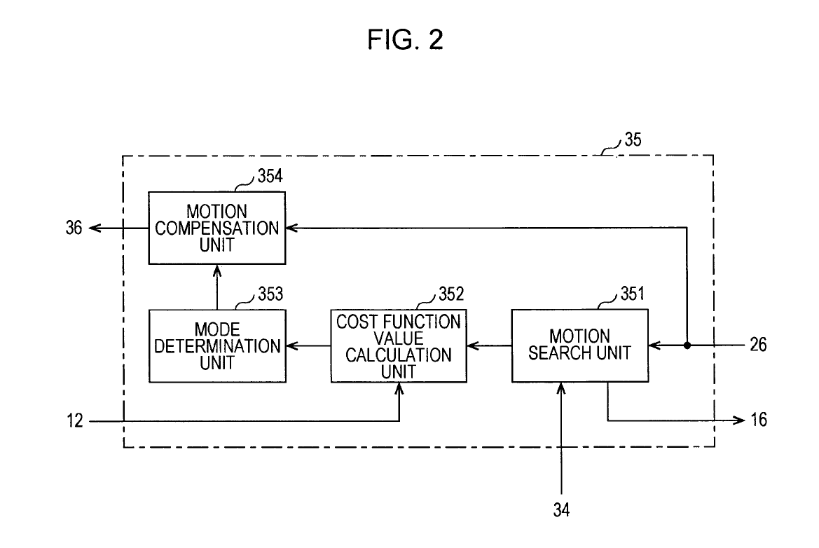

FIG. 2 illustrates a configuration of the LMB motion prediction and compensation unit 35. The LMB motion prediction and compensation unit 35 has a motion search unit 351, a cost function value calculation unit 352, a mode determination unit 353, and a motion compensation unit 354.

The motion search unit 351 performs a motion search by using the image data of the macro block and the decoding image data after the filter processing which is stored in the frame memory 25 to detect a motion vector. Also, the motion search unit 351 performs the detection of the motion vector for each prediction block size.

The cost function value calculation unit 352 performs the calculation of the cost function value for each prediction block size and the calculation of the cost function value in a prediction mode of a skipped macro block or a direct mode.

The mode determination unit 353 selects a prediction block size or a prediction mode in which the cost function value in the macro block unit becomes lowest from the cost function value obtained for each prediction block size and each prediction mode to determine the LMB optimal inter prediction mode.

The motion compensation unit 354 generates the prediction image data by using the motion vector detected by the motion search unit 351 and the decoding image data after the filter processing which is stored in the frame memory 25. The motion compensation unit 354 outputs the generated prediction image data, the cost function value, and the prediction mode information related to the LMB optimal inter prediction mode to the prediction image and optimal mode selection unit 36.

<3. Regarding Block>

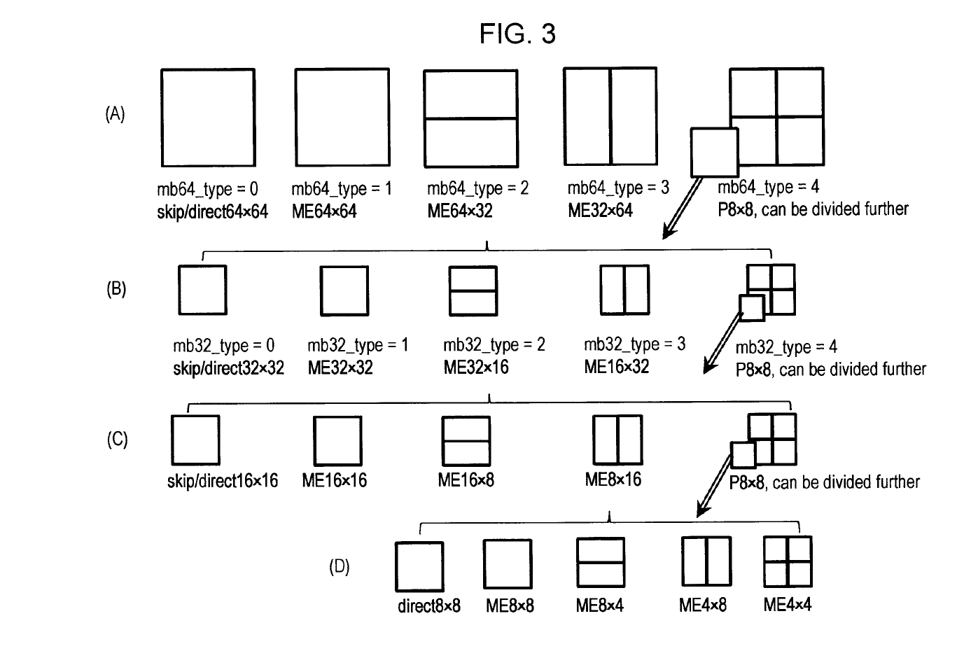

FIG. 3 illustrates prediction block sizes (motion compensation block sizes) used for the image coding processing. In the H.264/AVC system, as illustrated in (C) and (D) of FIG. 3, macro block sizes of 16×16 pixels to 4×4 pixels are prescribed. Also, in a case where a block having a size larger than the H.264/AVC system is used, for example, in a case where a macro block of 32×32 pixels (LMB32) is used, a block size illustrated in (B) of FIG. 3 is prescribed. Also, for example, in a case where a macro block of 64×64 pixels (LMB64) is used, a block size illustrated in (A) of FIG. 3 is prescribed.

Furthermore, if the macro block is enlarged, when the macro block is sequentially set in the horizontal direction and the vertical direction from the position on the upper left corner of the coding target image, a case may occur that an edge block having a size smaller than the block size of the block set by the number of pixels is generated at positions in the right edge part and the lower edge part.

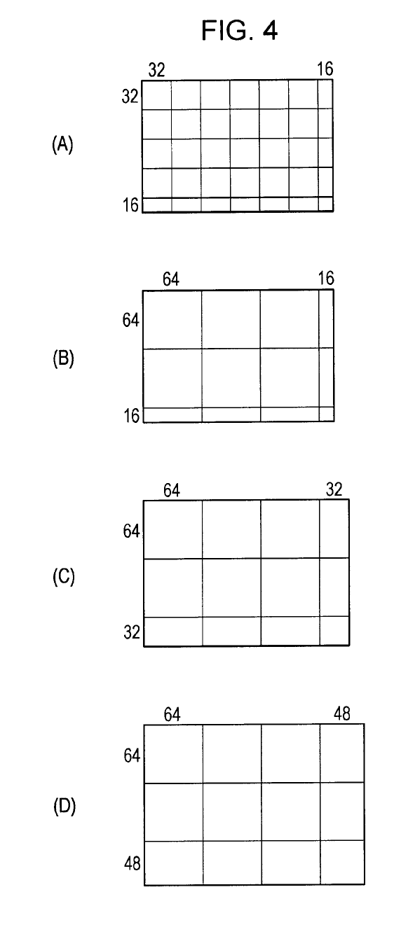

For example, it is supposed that the numbers of pixels in the horizontal direction and the vertical direction of the frame image are integral multiples of 16×16 pixels corresponding to the macro block in the H.264/AVC system. In this case, if the macro block is 32×32 pixels, when the macro block is sequentially set from the position on the upper left corner of the frame image, a case may occur that an edge block having a width of 16 pixels for one of the sides is generated. For example, (A) of FIG. 4 illustrates a case in which edge blocks having 16 pixels for one of the sides are generated in the right edge part and the lower edge part. Also, the macro block is 64×64 pixels, when the macro block is sequentially set from the position on the upper left corner of the frame image, a case may occur that an edge block having 16 pixels, 32 pixels, or 48 pixels for one of the sides is generated. For example, (B) of FIG. 4 illustrates a case in which edge blocks having 16 pixels for one of the sides are generated in the right edge part and the lower edge part. Also, (C) of FIG. 4 illustrates a case in which edge blocks having 32 pixels for one of the sides are generated in the right edge part and the lower edge part, and (D) of FIG. 4, illustrates a case in which edge blocks having 48 pixels for one of the sides are generated in the right edge part and the lower edge part.

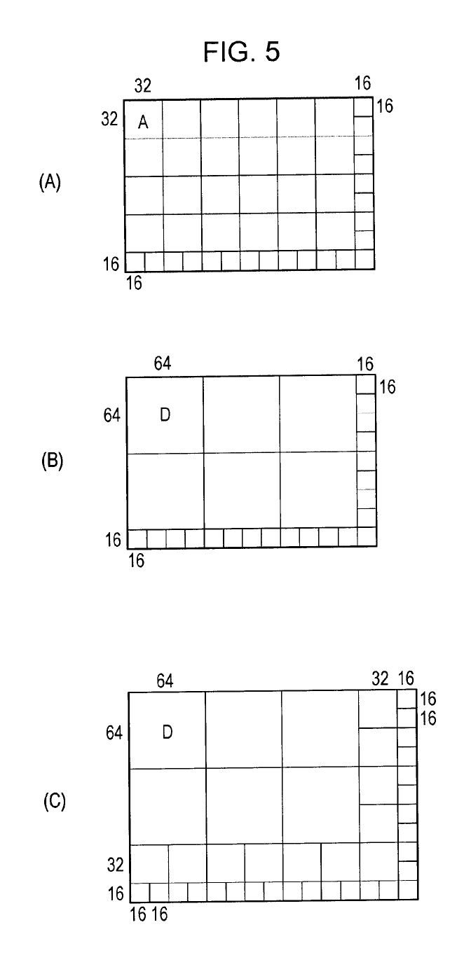

Herein, it is possible to carry out the motion compensation by setting the prediction block size smaller than or equal to 16×16 pixels with regard to the edge block similarly as in the H.264/AVC system. However, the prediction block size is set to be smaller than or equal to 16×16 pixels, as exemplified by (A) to (C) of FIG. 5, the number of prediction blocks in the edge block is increased, and it becomes difficult to reduce the data amount of the coding data. For example, even in a case where the cost function value is decreased when the motion compensation is carried out at the prediction block size larger than 16×16 pixels, since the block size is smaller than or equal to 16×16 pixels, it becomes difficult to reduce the data amount of the coding data.

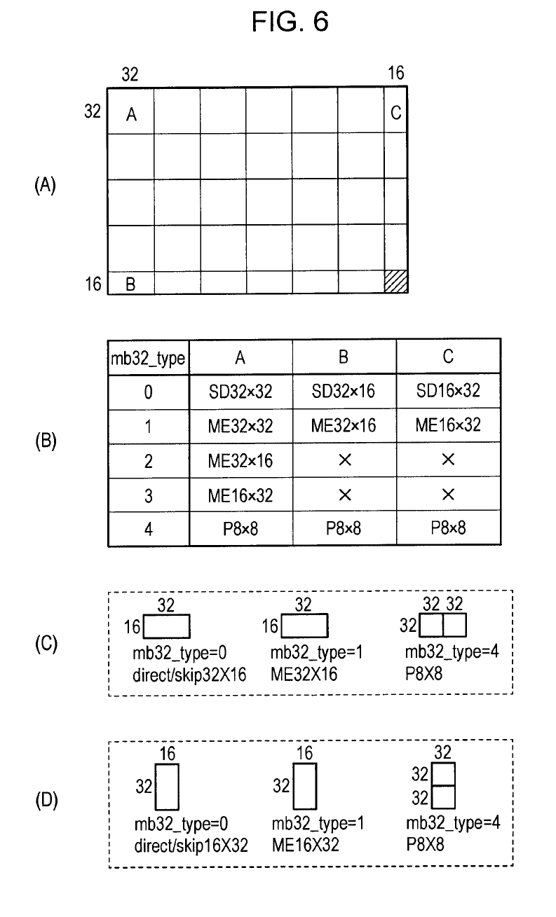

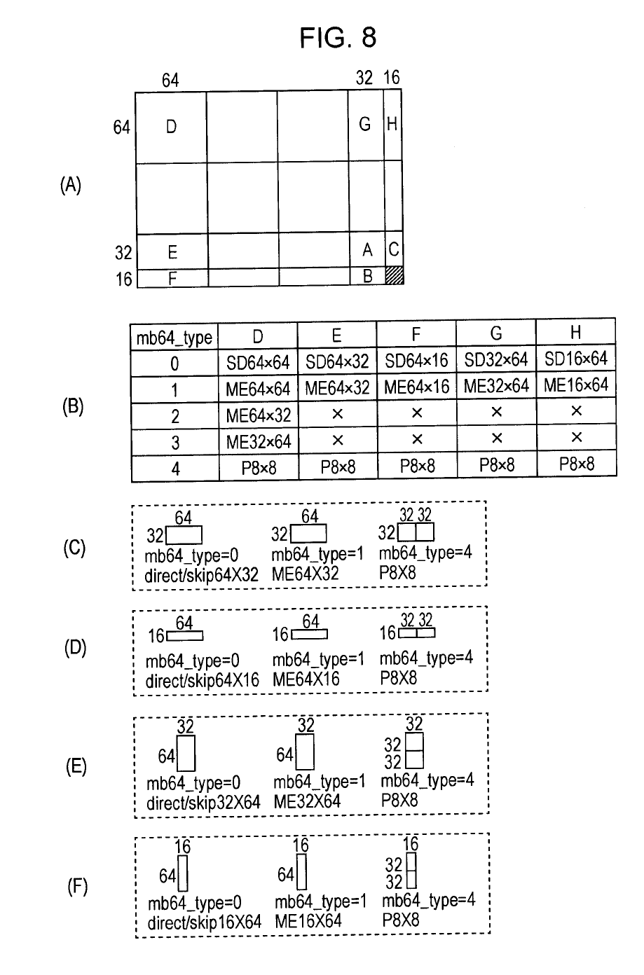

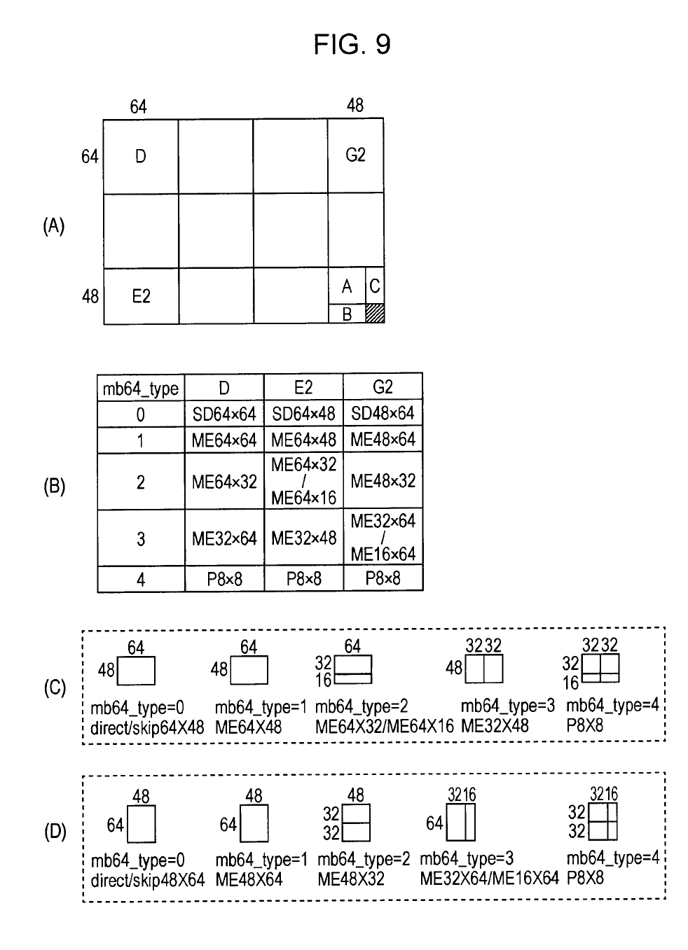

Therefore, according to this invention, for example, in a case where the macro block having a size larger than the H.264/AVC system is used, by setting a non-square region determined as the edge block as a target, the determination on the LMB optimal inter prediction mode is carried out while including the prediction block size corresponding to the size of the region determined as the edge block or the prediction block size corresponding to the size of the plural non-square regions obtained by dividing the region determined as the edge block in one of the directions of the horizontal direction and the vertical direction. Also, with regard to the square region determined as the edge block and the square region generated after the division, the determination on the LMB optimal inter prediction mode may be carried out while including the prediction block size set for the macro block at the lower level having a size smaller than the macro block. It should be noted that FIG. 6, FIG. 8, and FIG. 9 illustrate a case in which the prediction is carried out while including the prediction block size corresponding to the size of the region determined as the edge block and the prediction block size corresponding to the size of the plural non-square regions obtained by dividing the region determined as the edge block in one of the directions of the horizontal direction and the vertical direction.

FIG. 6 illustrates a case in which the macro block is 32×32 pixels. (A) of FIG. 6 illustrates a case in which the macro block is set as 32×32 pixels. Prediction block sizes in a case where the macro block is set as 32×32 pixels are a block A of 32×32 pixels, a block B of 32×16 pixels, and a block C of 16×32 pixels. In this manner, when the prediction block sizes are set, it is possible to set the blocks larger than 16×16 pixels while the edge blocks are set as the targets. It should be noted that a shaded part indicates a region of the macro block 16×16 pixels in related art (the same applies in FIG. 8 and FIG. 9)

(B) of FIG. 6 illustrates the macro block type mb32 type with respect to the blocks A, B, and C. With regard to the block A of 32×32 pixels, a macro block type “0” indicates the macro block mode referred to as skipped macro block or the direct mode (SD32×32). A macro block type “1” indicates that the motion compensation is carried out at the block size of 32×32 pixels (ME32×32). A macro block type “2” indicates that the motion compensation is carried out for each block while the block A is set as two blocks of 32×16 pixels (ME32×16). A macro block type “3” indicates that the motion compensation carried out for each block while the block A is set as two blocks of 16×32 pixels (ME16×32). A macro block type “4” indicates that the division is conducted into a block size at a lower level similarly as in FIG. 3 (P8×8).

With regard to the block B of 32×16 pixels corresponding to the edge block, the macro block type “0” indicates the macro block mode referred to as skipped macro block or the direct mode (SD32×16). The macro block type “1” indicates that the motion compensation is carried out at the block size of 32×16 pixels (ME32×16). The macro block type “4” indicates that the division is conducted into a block size at a lower level (P8×8). It should be noted that (C) of FIG. 6 illustrates the block B.

With regard to the block C of 16×32 pixels corresponding to the edge block, the macro block type “0” indicates the macro block mode referred to as skipped macro block or the direct mode (SD16×32). The macro block type “1” indicates that the motion compensation is carried out at the block size of 16×32 pixels (ME16×32). The macro block type “4” indicates that the division is conducted into a block size at a lower level (P8×8). It should be noted that (D) of FIG. 6 illustrates the block C.

Also, with regard to the square region corresponding to the edge block on the lower right of FIG. 6, the prediction block size set for the macro block (16×16 pixels) at a lower level having a size smaller than the macro block is used as illustrated in (C) and (D) of FIG. 3.

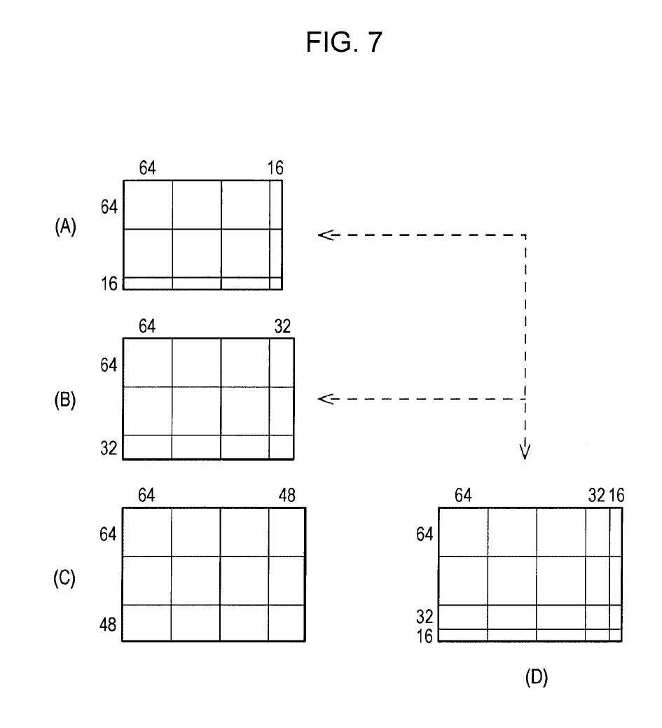

FIG. 7 indicates an edge block at a time when the macro block is set as 64×64 pixels. In a case where the numbers of pixels in the horizontal direction and the vertical direction of the frame image are integral multiples of 16×16 pixels corresponding to the macro block in the H.264/AVC system, if the macro block is 64×64 pixels, when the macro block is sequentially set from the position on the upper left corner of the frame image, an edge block having a width of 16 pixels as illustrated in (A) of FIG. 7, an edge block having a width of 32 pixels as illustrated in (B) of FIG. 7, and an edge block having a width of 48 pixels as illustrated in (C) of FIG. 7 may be generated in some cases. Also, as illustrated in (D) of FIG. 7, an edge block having a width of 48 pixels can be represented by the edge blocks illustrated in (A) and (B) of FIG. 7. Therefore, if the macro block type is set with respect to (C) and (D) of FIG. 7, it is not necessary to set the macro block type with regard to (A) and (B) of FIG. 7.

(A) of FIG. 8 illustrates a case in which the macro block is set as 64×64 pixels. A variable block size in a case where the macro block is set as 64×64 pixels is a block D of 64×64 pixels, a block E of 64×32 pixels, a block F of 64×16 pixels, a block G of 32×64 pixels, and a block H of 16×64 pixels. In this manner, when the variable block sizes are set, it is possible to set the blocks larger than 16×16 pixels while the edge blocks are set as the targets. It should be noted that in (A) of FIG. 8, the blocks A, B, and C are similar to the case illustrated in FIG. 6.

(B) of FIG. 8 illustrates the macro block type mb64_type with respect to the blocks D, E, F, G, and H. With regard to the block D of 64×64 pixels, the macro block type “0” indicates the macro block mode referred to as skipped macro block or the direct mode (SD64×64). The macro block type “1” illustrates that the motion compensation is carried out at the block size of 64×64 pixels (ME64×64). The macro block type “2” indicates that the motion compensation is carried out for each block (ME64×32) while the block D is set as two blocks of 64×32 pixels. The macro block type “3” indicates that the motion compensation is carried out for each block (ME32×64) while the block A is set as two blocks of 32×64 pixels. The macro block type “4” indicates that the division is conducted into a block size at a lower level (P8×8).

With regard to the block E of 64×32 pixels corresponding to the region after the division of the edge block, the macro block type “0” indicates the macro block mode referred to as skipped macro block or the direct mode (SD64×32). The macro block type “1” indicates that the motion compensation is carried out at the block size of at the block size of 64×32 pixels (ME64×32). The macro block type “4” indicates that the division is conducted into a block size at a lower level (P8×8). It should be noted that (C) of FIG. 8 illustrates the block E.

With regard to the block F of 64×16 pixels corresponding to the region after the division of the edge block, the macro block type “0” indicates the macro block mode referred to as skipped macro block or the direct mode (SD64×16). The macro block type “1” indicates that the motion compensation is carried out at the block size of 64×16 pixels (ME64×16). The macro block type “4” indicates that the division is conducted into a block size at a lower level (P8×8). It should be noted that (D) of FIG. 8 illustrates the block F.

With regard to the block G of 32×64 pixels corresponding to the region after the division of the edge block, the macro block type “0” indicates the macro block mode referred to as skipped macro block or the direct mode (SD32×64). The macro block type “1” indicates that the motion compensation is carried out at the block size of 32×64 pixels (ME32×64). The macro block type “4” indicates that the division is conducted into a block size at a lower level (P8×8). It should be noted that (E) of FIG. 8 illustrates the block G.

With regard to the block H of 16×64 pixels corresponding to the region after the division of the edge block, the macro block type “0” indicates the macro block mode referred to as skipped macro block or the direct mode (SD16×64). The macro block type “1” indicates that the motion compensation is carried out at the block size of 16×64 pixels (ME16×64). The macro block type “4” indicates that the division is conducted into a block size at a lower level (P8×8). It should be noted that (F) of FIG. 8 illustrates the block H.

Also, with regard to the square region corresponding to the edge block on the lower right of FIG. 8 and the square region generated after the division, the prediction block size set for the macro block at a lower level having a size smaller than the macro block is used.

(A) of FIG. 9 indicates another case in which the macro block is set as 64×64 pixels. A variable block size in a case where the macro block is 64×64 pixels is the block D of 64×64 pixels, a block E2 of 64×48 pixels, and a block G2 of 48×64 pixels. In this manner, when the variable block sizes are set, it is possible to set the blocks larger than 16×16 pixels while the edge blocks are set as the targets. It should be noted that in (A) of FIG. 9, the blocks A, B, and C are similar to the case illustrated in FIG. 6.

(B) of FIG. 9 indicates the macro block type mb64 type with respect to the blocks D, E2, and G2. It should be noted that the block D is similar to FIG. 8.

With regard to the block E2 of 64×48 pixels corresponding to the edge block, the macro block type “0” indicates the macro block mode referred to as skipped macro block or the direct mode (SD64×48). The macro block type “1” indicates that the motion compensation is carried out at the block size of 64×48 pixels (ME64×48). The macro block type “2” indicates that the motion compensation is carried out while the block of 64×48 pixels is set as blocks of 64×32 pixels and 64×16 images (ME64×32/64×16). The macro block type “3” indicates that the motion compensation is carried out while the block of 64×48 pixels is set as two blocks of 32×48 pixels (ME32×48). The macro block type “4” indicates that the division is conducted into a block size at a lower level (P8×8). It should be noted that (C) of FIG. 9 illustrates the block E2.

With regard to the block G2 of 64×48 pixels corresponding to the edge block, the macro block type “0” indicates the macro block mode referred to as skipped macro block or the direct mode (SD48×64). The macro block type “1” indicates the motion compensation is carried out at the block size of 48×64 pixels (ME48×64). The macro block type “2” indicates that the motion compensation is carried out while the block of 48×64 pixels is set as two blocks of 48×32 pixels (ME48×32). The macro block type “3” indicates that the motion compensation is carried out while the block of 48×64 pixels is set as blocks of 32×64 pixels and 16×64 (ME32×64/16×64). The macro block type “4” indicates that the division is conducted into a block size at a lower level (P8×8). It should be noted that (D) of FIG. 9 illustrates the block G2.

Also, with regard to the square region corresponding to the edge block on the lower right of FIG. 9 and the square region generated after the division, the prediction block size set for the macro block at a lower level having a size smaller than the macro block is used.

It should be noted that as a purpose of a further improvement in the coding efficiency as compared with the H.264/AVC system, by JCTVC (Joint Collaboration Team—Video Coding) which is a joint standard-setting organization of ITU-T and ISO/IEC, a standardization of a coding system referred to as HEVC (High Efficiency Video Coding) is progressed. As of September 2010, “Test Model under Consideration”, (JCTVC-B205) is issued as Draft.

According to the HEVC coding system, it is possible to use a block with a further expanded size as compared with the H.264/AVC system, and CU (Coding Unit) is defined.

A CU is also referred to as CTB (Coding Tree Block) and plays a role similar to the macro block in the H.264/AVC system. Also, whereas the macro block is fixed as the size of 16×16 pixels in the H.264/AVC system, the size is not fixed in the HEVC coding system and is specified in image compression information in each of sequences.

In particular, a CU having a largest size is referred to as LCU (Largest Coding Unit), and also a CU having a smallest size is referred to as SCU (Smallest Coding Unit). In a sequence parameter set included in the image compression information, these sizes are specified but respectively limited to squares and sizes represented by a power of 2.

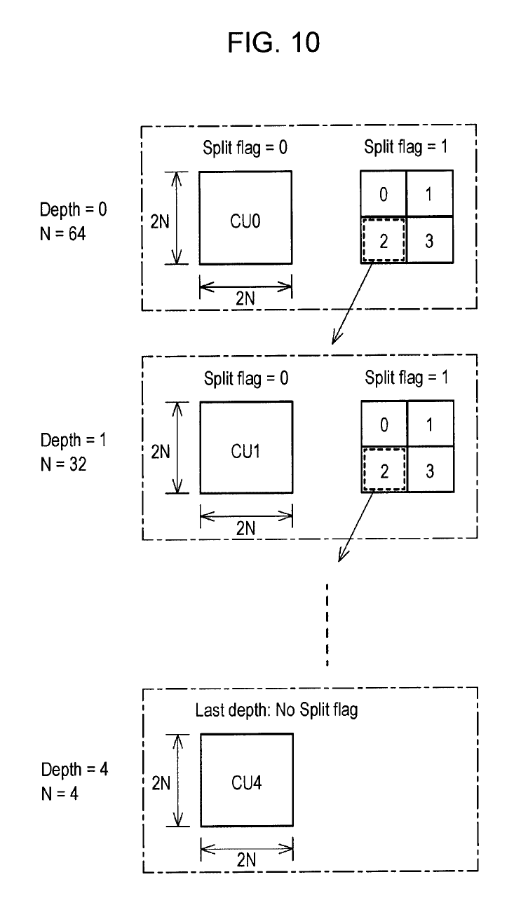

FIG. 10 illustrates examples of the CU defined in the HEVC coding system. In the examples of the drawing, the size of the LCU is 128, and a largest hierarchical depth is 5. When a value of split_flag is 1, CU with a size of 2N×2N is divided into CUs with a size of N×N at a hierarchy one level below.

Furthermore, the CU is divided into PU (Prediction Unit) which is a unit of the intra or inter prediction and also divided into TU (Transform Unit) which is a unit of the orthogonal transform.

The CU is further divided into PU which is a unit of the intra or inter prediction and also divided into TU which is a unit of the orthogonal transform, so that the prediction processing and the orthogonal transform processing are carried out. Currently, in the HEVC coding system, in addition to 4×4 and 8×8, it is possible to use 16×16 and 32×32 orthogonal transform.

In the present specification, the block and the macro block include the concepts of the CU, the PU, and the TU described above and are not limited to blocks the sizes of which are fixed.

<4. Operation of Image Coding Apparatus>

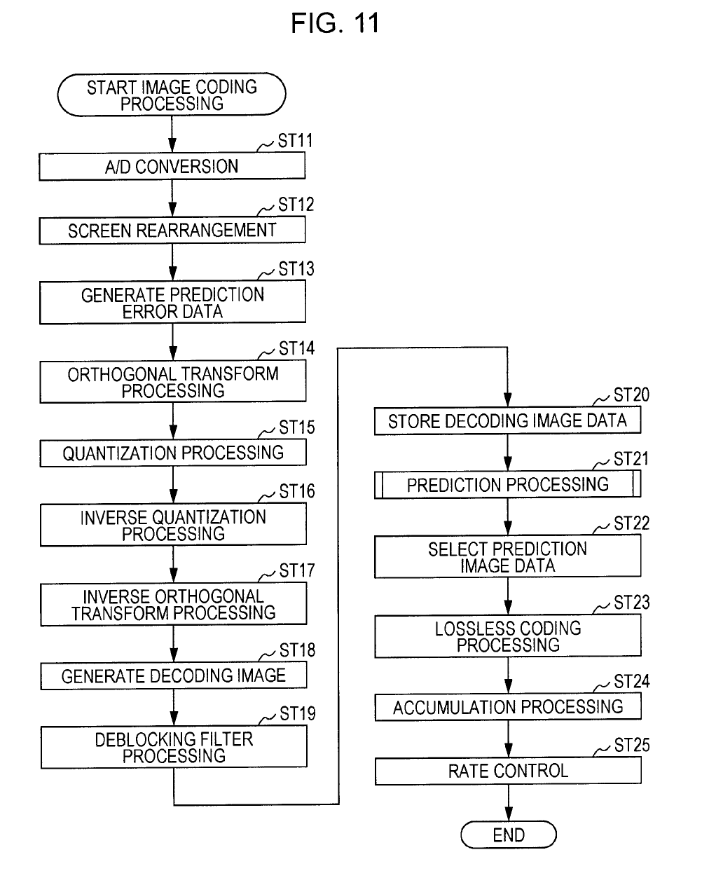

Next, the image coding processing operation will be described. FIG. 11 is a flow chart illustrating the image coding processing operation. In step ST11, the A/D conversion unit 11 subjects an input image signal to A/D conversion.

In step ST12, the screen rearrangement buffer 12 performs the screen rearrangement. The screen rearrangement buffer 12 stores the image data supplied from the A/D conversion unit 11 and performs a rearrangement from an order of displaying the respective pictures to an order of coding.

In step ST13, the subtraction unit 13 performs the generation of the prediction error data. The subtraction unit 13 calculates a difference between image data of the images rearranged in step ST12 and the prediction image data selected by the prediction image and optimal mode selection unit 36 to generate the prediction error data. The prediction error data has a small data amount as compared with the original image data. Therefore, the data amount can be compressed as compared with the case in which the image data is directly coded. It should be noted that when the selection of the prediction image is carried out for each slice by the prediction image and optimal mode selection unit 36, in the slice where the prediction image supplied from the AVC intra prediction unit 31 or the LMB intra prediction unit 32 is selected, the intra prediction is carried out. Also, in the slice where the prediction image supplied from the AVC motion prediction and compensation unit 33 or the LMB motion prediction and compensation unit 35 is selected, the inter prediction is carried out.

In step ST14, the orthogonal transform unit 14 performs the orthogonal transform processing. The orthogonal transform unit 14 subjects the prediction error data supplied from the subtraction unit 13 to the orthogonal transform. To be specific, the orthogonal transform such as discrete cosine transform or Karhunen-Loeve transform is carried out on the prediction error data, and the transform coefficient data is output.

In step ST15, the quantization unit 15 performs the quantization processing. The quantization unit 15 quantizes the transform coefficient data. At the time of the quantization, as described in a processing in step ST25 which will be described below, a rate control is carried out.

In step ST16, the inverse quantization unit 21 performs the inverse quantization processing. The inverse quantization unit 21 inversely quantizes the transform coefficient data quantized by the quantization unit 15 at a characteristic corresponding to the characteristic of the quantization unit 15.

In step ST17, the inverse orthogonal transform unit 22 performs the inverse orthogonal transform processing. The inverse orthogonal transform unit 22 performs the inverse orthogonal transform on the transform coefficient data inversely quantized by the inverse quantization unit 21 at a characteristic corresponding to the characteristic of the orthogonal transform unit 14.

In step ST18, the addition unit 23 performs the generation of the decoding image data. The addition unit 23 adds the prediction image data supplied from the prediction image and optimal mode selection unit 36 to the data after the inverse orthogonal transform at the position corresponding to this prediction image to generate the decoding image data.

In step ST19, the deblocking filter 24 performs a filter processing. The deblocking filter 24 subjects the decoding image data output from the addition unit 23 to filtering to remove the block distortion.

In step ST20, the frame memory 25 stores the decoding image data. The frame memory 25 stores the decoding image data before the filter processing and the decoding image data after the filter processing.

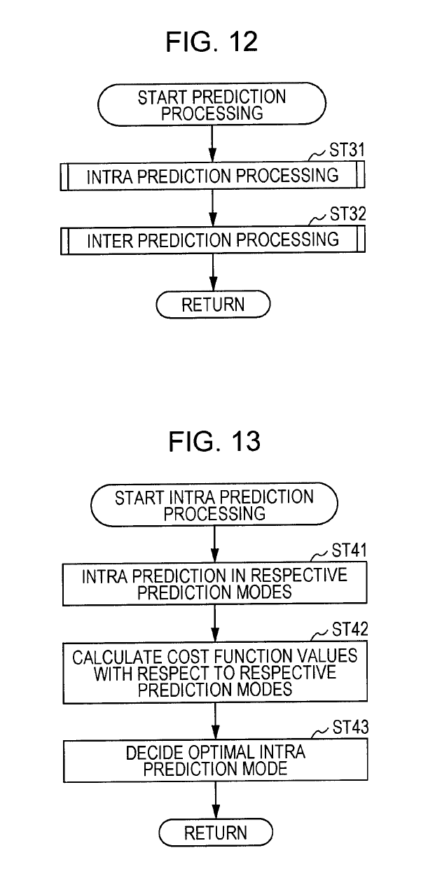

In step ST21, the AVC intra prediction unit 31, the LMB intra prediction unit 32, the AVC motion prediction and compensation unit 33, and the LMB motion prediction and compensation unit 35 respectively perform the prediction processing. That is, the AVC intra prediction unit 31 and the LMB intra prediction unit 32 perform the intra prediction processing in the intra prediction mode, and the AVC motion prediction and compensation unit 33 and the LMB motion prediction and compensation unit 35 perform the motion prediction and compensation processing in the inter prediction mode. Through this processing, the AVC intra prediction unit 31 and the LMB intra prediction unit 32 select the optimal intra prediction mode and supply the prediction image generated in the optimal intra prediction mode as well as the cost function value and the prediction mode information thereof to the prediction image and optimal mode selection unit 36. Also, the AVC motion prediction and compensation unit 33 and the LMB motion prediction and compensation unit 35 select the optimal inter prediction mode and supply the prediction image generated in the optimal inter prediction mode as well as the cost function value and the prediction mode information thereof to the prediction image and optimal mode selection unit 36. It should be noted that a detail of the prediction processing will be described below with reference to FIG. 12.

In step ST22, the prediction image and optimal mode selection unit 36 performs a selection of the prediction image data. The prediction image and optimal mode selection unit 36 selects the optimal mode in which the cost function value becomes smallest on the basis of the respective cost function values output from the AVC intra prediction unit 31, the LMB intra prediction unit 32, the AVC motion prediction and compensation unit 33, and the LMB motion prediction and compensation unit 35. Furthermore, the prediction image and optimal mode selection unit 36 supplies the prediction image data in the selected optimal mode to the subtraction unit 13 and the addition unit 23. This prediction image data is utilized in the computations in steps ST13 and ST18 as described above. Also, the information related to the optimal mode is supplied to the lossless coding unit 16.

In step ST23, the lossless coding unit 16 performs the lossless coding processing. The lossless coding unit 16 subjects the quantization data output from the quantization unit 15 to the lossless coding. That is, the lossless coding such as the variable length coding or the arithmetic coding is carried out on the quantization data, and the data is compressed. At this time, the prediction mode information or the like that is input to the lossless coding unit 16 in step ST22 described above (including, for example, the prediction mode, the prediction block size, the motion vector information, the reference picture information, and the like) is also subjected to the lossless coding. Furthermore, the lossless coding data on the prediction mode information is added to the header information of the coding stream generated by subjecting the quantization data to the lossless coding.

In step ST24, the accumulation buffer 17 accumulates the coding stream. The coding streams accumulated in this accumulation buffer 17 are appropriately read out to be transmitted via the transmission path to the decoding side.

In step ST25, the rate control unit 18 performs the rate control. When the accumulation buffer 17 accumulates the coding stream, the rate control unit 18 controls a rate of the quantization operation by the quantization unit 15 so that an over flow or an under flow does not occur in the accumulation buffer 17.

Next, with reference to a flow chart of FIG. 12, the prediction processing in step ST21 of FIG. 11 will be described.

In step ST31, the AVC intra prediction unit 31 and the LMB intra prediction unit 32 perform the intra prediction processing. The AVC intra prediction unit 31 performs the intra prediction on the image of the processing target block in all the candidate intra prediction modes. It should be noted that the filter processing is not carried out by the deblocking filter 24 on the image data of the decoding image referred in the intra prediction, and the decoding image data stored in the frame memory 25 is used. A detail of the intra prediction processing will be described below, but through this processing, the intra prediction processing is carried out in all the candidate intra prediction modes, and the cost function value is calculated in all the candidate intra prediction modes. Then, on the basis of the calculated cost function values, one intra prediction mode in which the coding efficiency becomes highest is selected from all the intra prediction modes.

The LMB intra prediction unit 32 performs the intra prediction on the image of the processing target block in all the candidate intra prediction modes. It should be noted that the filter processing is not carried out by the deblocking filter 24 on the image data of the referred decoding image, and the decoding image data stored in the frame memory 25 is used. Through this processing, the intra prediction processing is carried out in all the candidate intra prediction modes, and the cost function value is calculated in all the candidate intra prediction modes. Then, on the basis of the calculated cost function values, one intra prediction mode in which the coding efficiency becomes highest is selected from all the intra prediction modes.

In step ST32, the AVC motion prediction and compensation unit 33 and the LMB motion prediction and compensation unit 35 perform the inter prediction processing. The AVC motion prediction and compensation unit 33 uses the decoding image data after the filter processing stored in the frame memory 25 to perform the inter prediction processing in all the candidate inter prediction modes (all the prediction block sizes). A detail of the inter prediction processing will be described below, but through this processing, the prediction processing is carried out in all the candidate inter prediction modes, and the cost function value is calculated in all the candidate inter prediction modes. Then, on the basis of the calculated cost function values, one inter prediction mode in which the coding efficiency becomes highest is selected from all the inter prediction modes.

The LMB motion prediction and compensation unit 35 uses the decoding image data after the filter processing stored in the frame memory 25 to perform the inter prediction processing in all the candidate inter prediction modes (all the prediction block sizes). Through this processing, the prediction processing is carried out in all the candidate inter prediction modes, the cost function value is calculated in all the candidate inter prediction modes. Then, on the basis of the calculated cost function values, one inter prediction mode in which the coding efficiency becomes highest is selected from all the inter prediction modes.

Next, the intra prediction processing in step ST31 of FIG. 12 will be described with reference to a flow chart of FIG. 13.

In step ST41, the AVC intra prediction unit 31 and the LMB intra prediction unit 32 perform the intra prediction in the respective prediction modes. The AVC intra prediction unit 31 and the LMB intra prediction unit 32 use the decoding image data before the filter processing stored in the frame memory 25 to generate the prediction image data for each intra prediction mode.

In step ST42, the AVC intra prediction unit 31 and the LMB intra prediction unit 32 calculate the cost function values with respect to the respective prediction modes. For the cost function value, the calculation is carried out in either method of a High Complexity mode or a Low Complexity mode as defined by JM (Joint Model) corresponding to reference software in the H.264/AVC system.

That is, in the High Complexity mode, as the processing in step ST41, up to the lossless coding processing is tentatively carried out in all the candidate prediction modes, and the cost function value represented by the following expression (1) is calculated in the respective prediction modes.

Cost(ModeεΩ)=D+λ·R (1)

Ω denotes a whole set of candidate prediction modes for coding the relevant block to the macro block. D denotes difference energy (distortion) between the decoding image in a case where the coding is carried out in the prediction mode and the input image. R denotes a generated code amount including an orthogonal transformation coefficient, prediction mode information, and the like, and λ denotes a Lagrange multiplier factor given as a function for a quantization parameter QP.

To elaborate, to carry out the coding in the High Complexity Mode, the above-mentioned parameters D and R are calculated, and it is therefore necessary to perform a tentative encode processing in all the candidate prediction modes, so that a higher computation amount is needed.

On the other hand, in the Low Complexity mode, as the processing in step ST41, with regard to all the candidate prediction modes, the generation of the prediction image and the calculation of up to the header bit such as the motion vector information and the prediction mode information are carried out, and the cost function value represented by the following expression (2) is calculated in the respective prediction modes.

Cost(ModeεΩ)=D+QPtoQuant(QP)·Header_Bit (2)

Ω denotes a whole set of candidate prediction modes for coding the relevant block to the macro block. D denotes difference energy (distortion) between the decoding image in a case where the coding is carried out in the prediction mode and the input image. Header_Bit denotes a header bit with respect to the prediction mode, and QPtoQuant denotes a function given as a function for the quantization parameter QP.

That is, in the Low Complexity Mode, with regard to each of the prediction modes, it is necessary to perform the prediction processing, but it is not necessary to perform the decoding image that far, and therefore the realization at the computation amount lower than that in the High Complexity Mode is enabled.

In step ST43, the AVC intra prediction unit 31 and the LMB intra prediction unit 32 decide the optimal intra prediction mode. On the basis of the cost function values calculated in step ST42, among those, the AVC intra prediction unit 31 and the LMB intra prediction unit 32 select the intra prediction mode in which the cost function value becomes smallest to be decided as the optimal intra prediction mode.

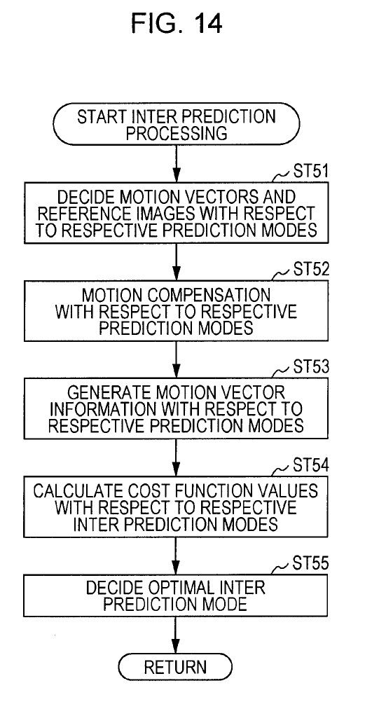

Next, the inter prediction processing in step ST32 of FIG. 12 will be described. FIG. 14 illustrates the inter prediction processing performed by the AVC motion prediction and compensation unit 33.

In step ST51, the AVC motion prediction and compensation unit 33 decides the motion vectors and the reference images respectively in the respective prediction modes. That is, the motion vectors and the reference images are decided respectively with regard to the blocks of the processing target in the respective prediction modes.

In step ST52, the AVC motion prediction and compensation unit 33 performs the motion compensation in the respective prediction modes. The AVC motion prediction and compensation unit 33 performs the motion compensation on the reference image with regard to the respective prediction modes on the basis of the motion vector decided in step ST51 and generates the prediction image data with regard to the respective prediction modes.

In step ST53, the AVC motion prediction and compensation unit 33 performs the generation of the motion vector information in the respective prediction modes. The AVC motion prediction and compensation unit 33 generates the motion vector information included in the coding stream with regard to the respective prediction modes. For example, a prediction motion vector is decided by using a median prediction or the like to generate the motion vector information indicating a difference between the motion vector detected by the motion prediction and the prediction motion vector. The thus generated motion vector information is also used in the calculation of the cost function value in the next step ST54, and in a case where the prediction image dealt with by the prediction image and optimal mode selection unit 36 is finally selected, the prediction image is included in the prediction mode information to be output to the lossless coding unit 16.

In step ST54, the AVC motion prediction and compensation unit 33 performs the calculation of the cost function value in the respective inter prediction modes. The AVC motion prediction and compensation unit 33 uses the above-mentioned expression (1) or expression (2) to perform the calculation of the cost function value. It should be noted that the calculation of the cost function value with respect to the inter prediction mode also includes an evaluation on the cost function value in a Skip Mode and a Direct Mode defined in the H.264/AVC system.

In step ST55, the AVC motion prediction and compensation unit 33 decides the optimal inter prediction mode. On the basis of the cost function values calculated in step ST54, the AVC motion prediction and compensation unit 33 selects a prediction mode in which the cost function value becomes smallest among those to be decided as the optimal inter prediction mode.

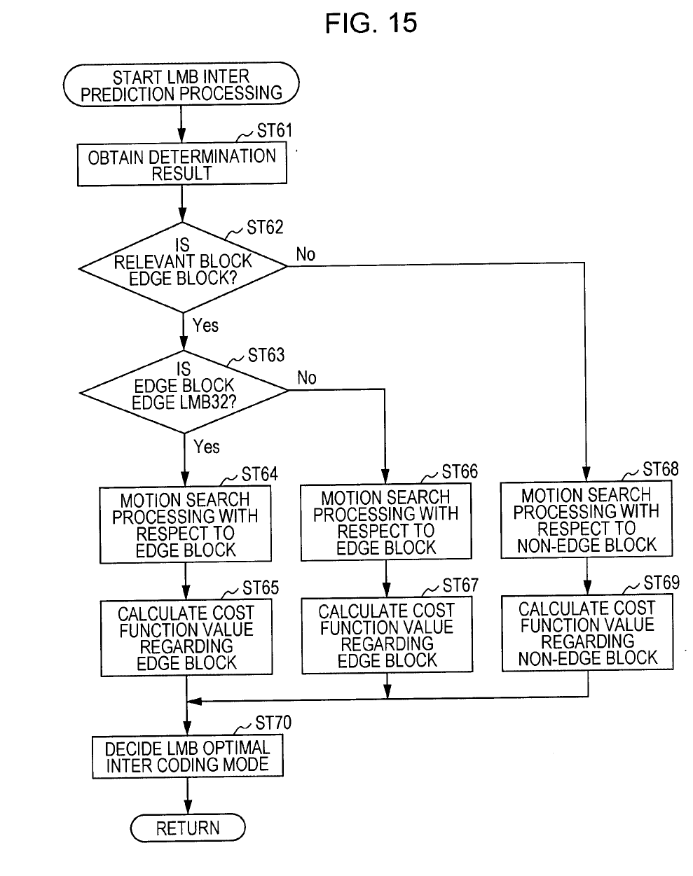

FIG. 15 illustrates an LMB inter prediction processing performed by the LMB motion prediction and compensation unit 35.

In step ST61, the LMB motion prediction and compensation unit 35 obtains a determination result as to whether or not the relevant block is an edge block. The LMB motion prediction and compensation unit 35 obtains a determination result by the edge LMB determination unit 34 with respect to the macro block on which the coding is carried out and advances to step ST62.

In step ST62, the LMB motion prediction and compensation unit 35 determines whether or not the relevant block is an edge block. The LMB motion prediction and compensation unit 35 advances to step ST63 when the determination result obtained in step ST61 indicates the edge block and advances to step ST68 when the determination result does not indicate the edge block.

In step ST63, the LMB motion prediction and compensation unit 35 determines whether or not the edge block is an edge block (edge LMB32) at a time when the macro block is set as 32×32 pixels. The LMB motion prediction and compensation unit 35 advances to step ST64 in a case where the edge block is the edge LMB32 and advances to step ST66 in a case where the edge block is the edge block (edge LMB64) at a time when the macro block is set as 64×64 pixels.

In step ST64, the LMB motion prediction and compensation unit 35 performs a motion search processing with regard to the edge block (edge LMB32). To be specific, since the relevant block is equivalent to the block B, the block C, or the block of the square shape in FIG. 6, the motion search processing is carried out on the respective mb32_types of the equivalent block, and the flow advances to step ST65.

In step ST65, the LMB motion prediction and compensation unit 35 performs the calculation of the cost function value with regard to the edge block (edge LMB32). To be specific, since the relevant block is equivalent to the block B, the block C, or the block of the square shape in FIG. 6, the cost function value is calculated with regard to the respective mb32_types of the equivalent block, and the flow advances to step ST70.

It should be noted that in steps ST64 and 65, with regard to the region of the square shape, the motion search processing and the calculation of the cost function value are carried out at the prediction block size set for the macro block at a lower level having a size smaller than the macro block.

When the flow advances from step ST63 to step ST66, the LMB motion prediction and compensation unit 35 performs the motion search processing with regard to the edge block (edge LMB64) at a time when the macro block is set as 64×64 pixels. To be specific, since the relevant block is equivalent to the block E to the block H, the block E2, the block G2, or the block of the square shape in FIGS. 8 and 9, the motion search processing is carried out on the respective mb32 types of the equivalent block, and the flow advances to step ST67.

In step ST67, the LMB motion prediction and compensation unit 35 performs the calculation of the cost function value with regard to the edge block at a time when the macro block is set as 64×64 pixels. To be specific, since the relevant block is equivalent to the block E to the block H, the block E2, the block G2, or the block of the square shape in FIGS. 8 and 9, the cost function value is calculated with regard to the respective mb32 types of the equivalent block, and the flow advances to step ST70.

It should be noted that in steps ST66 and 67, with regard to the region of the square shape, the motion search processing and the calculation of the cost function value are carried out at the prediction block size set for the macro block at a lower level having a size smaller than the macro block.

When the flow advances from step ST62 to step ST68, the LMB motion prediction and compensation unit 35 performs the motion search processing on a non-edge block (equivalent to the macro block). To be specific, since the relevant block is equivalent to the block A of FIG. 6 or the block D of FIGS. 8 and 9, the motion search processing is carried out with regard to the respective mb32_types of the equivalent block or the respective mb64_types, and the flow advances to step ST69.

In step ST69, the LMB motion prediction and compensation unit 35 performs the calculation of the cost function value with regard to the non-edge block. To be specific, since the relevant block is equivalent to the block A of FIG. 6 or the block D of FIGS. 8 and 9, the cost function value is calculated with regard to the respective mb32_types of the equivalent block or the respective mb64_types, and the flow advances to step ST70.

In step ST70, the LMB motion prediction and compensation unit 35 decides the LMB optimal inter prediction mode. The LMB motion prediction and compensation unit 35 decides a prediction block size (motion compensation block size) at which the cost function values calculated in steps ST65, 67, and 69 become smallest as the LMB optimal inter prediction mode.

In this manner, according to the image coding apparatus and method of the invention of the present application, in a case where a block is set with respect to the image of the coding target, if the edge block having a size smaller than the block size of the block is generated, while the region determined as the edge block is set as a target, the LMB motion prediction and compensation unit 35 detects the prediction block size at which the coding efficiency is increased by using the prediction block size corresponding to the region size determined as the edge block and the prediction block size corresponding to the size of the plural non-square regions obtained by dividing the region determined as the edge block in one of the directions of the horizontal direction and the vertical direction. For this reason, the prediction block at which the coding efficiency becomes highest is detected, and when the coding processing on the image data is carried out at this detected prediction block size, in the edge block, it is possible to set a prediction block having a size larger than that in related art. Therefore, it is possible to reduce the data amount of the coding stream by decreasing the number of prediction blocks.

Also, the lossless coding unit 16 generates the coding stream without changing the syntax element irrespective of whether or not the block is the edge block. Therefore, even in a case where the prediction block size set in accordance with the edge block is used, it is not necessary to change the processing in the lossless coding unit 16.

<5. Configuration of Image Decoding Apparatus>

The coding stream generated by coding the input image is supplied via a predetermined transmission path, a recording medium, or the like to the image decoding apparatus to be decoded.

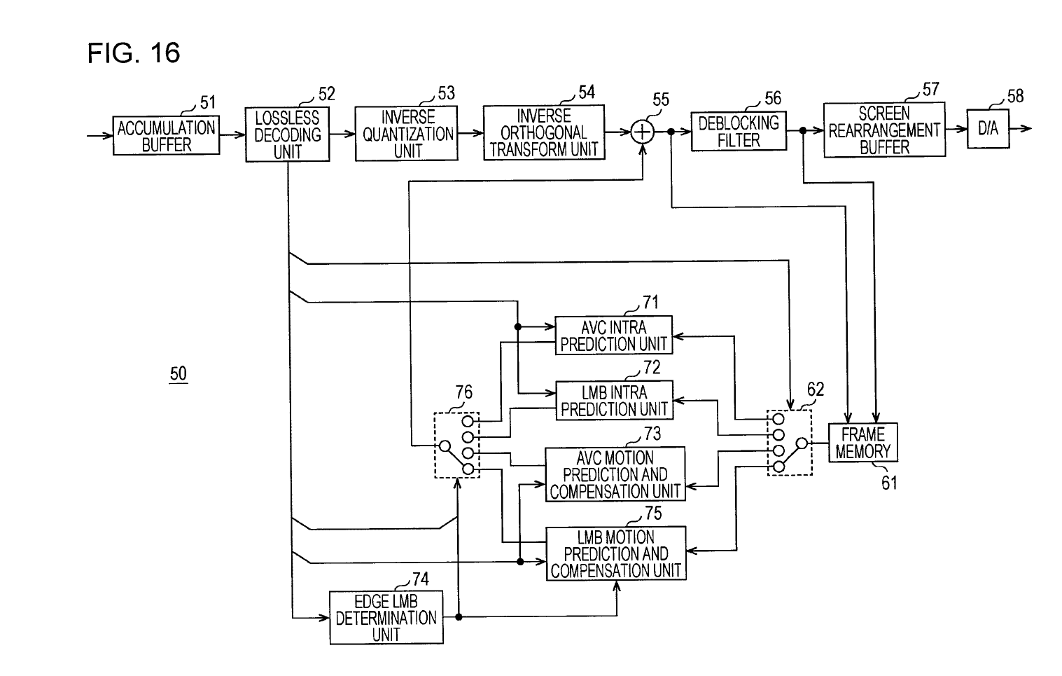

FIG. 16 illustrates a configuration of an image decoding apparatus. An image decoding apparatus 50 has an accumulation buffer 51, a lossless decoding unit 52, an inverse quantization unit 53, an inverse orthogonal transform unit 54, an addition unit 55, a deblocking filter 56, a screen rearrangement buffer 57, a D/A conversion unit 58, a frame memory 61, a selector 62, an AVC intra prediction unit 71, an LMB intra prediction unit 72, an AVC motion prediction and compensation unit 73, an edge LMB determination unit 74, an LMB motion prediction and compensation unit 75, and a selector 76.

The accumulation buffer 51 accumulates a transmitted coding stream. The lossless decoding unit 52 decodes the coding stream supplied from the accumulation buffer 51 in a system corresponding to the coding system of the lossless coding unit 16 of FIG. 1. Also, the lossless decoding unit 52 outputs the prediction mode information obtained by decoding the header information of the coding stream to the deblocking filter 56, the AVC intra prediction unit 71, the LMB intra prediction unit 72, the AVC motion prediction and compensation unit 73, and the LMB motion prediction and compensation unit 75.

The inverse quantization unit 53 inversely quantizes the quantization data decoded by the lossless decoding unit 52 in a system corresponding to the quantization system of the quantization unit 15 of FIG. 1. The inverse orthogonal transform unit 54 subjects the output of the inverse quantization unit 53 to the inverse orthogonal transform in a system corresponding to the orthogonal transform system of the orthogonal transform unit 14 of FIG. 1 to be output to the addition unit 55.

The addition unit 55 adds the data after the inverse orthogonal transform to the prediction image data supplied from the selector 76 to generate the decoding image data to be output to the deblocking filter 56 and the frame memory 61.

The deblocking filter 56 performs the filter processing on the decoding image data supplied from the addition unit 55 to remove the block distortion to be then supplied to the frame memory 61 for accumulation and also output to the screen rearrangement buffer 57.

The screen rearrangement buffer 57 performs a screen rearrangement of the images. That is, the order of the frames rearranged by the screen rearrangement buffer 12 of FIG. 1 for the order of the coding is rearranged to the original display order to be output to the D/A conversion unit 58.

The D/A conversion unit 58 subjects the image data supplied from the screen rearrangement buffer 57 to D/A conversion to be output to a display that is not illustrated in the drawing, so that the image is displayed.

The frame memory 61 holds the decoding image data before the filter processing supplied from the addition unit 55 and the decoding image data after the filter processing supplied from the deblocking filter 24.

On the basis of the prediction mode information supplied from the lossless decoding unit 52, when the decoding of the prediction block is performed where the intra prediction is carried out in the macro block prescribed in the H.264/AVC system, the selector 62 supplies the decoding image data before the filter processing read out from the frame memory 61 to the AVC intra prediction unit 71. On the basis of the prediction mode information supplied from the lossless decoding unit 52, when the decoding of the prediction block is performed where the intra prediction is carried out at the large macro block, the selector 26 supplies the decoding image data before the filter processing read out from the frame memory 61 to the LMB intra prediction unit 72. On the basis of the prediction mode information supplied from the lossless decoding unit 52, when the decoding of the prediction block is performed where the inter prediction is carried out at the macro block prescribed in the H.264/AVC system, the selector 62 supplies the decoding image data after the filter processing read out from the frame memory 61 to the AVC motion prediction and compensation unit 73. Furthermore, on the basis of the prediction mode information supplied from the lossless decoding unit 52, when the decoding of the prediction block is performed where the inter prediction is carried out at the large macro block, the selector 26 supplies the decoding image data after the filter processing read out from the frame memory 61 to the LMB motion prediction and compensation unit 75.

The AVC intra prediction unit 71 performs the generation of the prediction image on the basis of the prediction mode information supplied from the lossless decoding unit 52 and outputs the generated prediction image data to the selector 76. The LMB intra prediction unit 72 performs the generation of the prediction image on the basis of the prediction mode information supplied from the lossless decoding unit 52 and outputs the generated prediction image data to the selector 76.

The AVC motion prediction and compensation unit 73 performs the motion compensation on the basis of the prediction mode information supplied from the lossless decoding unit 52 and generates the prediction image data to be output to the selector 76. That is, on the basis of the motion vector information and the reference frame information included in the prediction mode information, the AVC motion prediction and compensation unit 73 performs the motion compensation at the motion vector based on the motion vector information with respect to the reference image indicated by the reference frame information to generate the prediction image data.

The edge LMB determination unit 74 performs the determination on the edge block similarly as in the edge LMB determination unit 34 illustrated in FIG. 1. The edge LMB determination unit 74 determines the edge block having a size smaller than the block size of this macro block on the basis of the image size of the decoding target image and the location of the macro block where the decoding processing is carried out. The edge LMB determination unit 74 can determine whether or not the relevant block is the edge block by using, for example, the numbers of pixels in the horizontal direction and the vertical direction of the decoding target image and the address information on the macro blocks to be sequentially decoded. Also, since the switching of the prediction modes is enabled not only in units of the frame but also in units of the slice, the determination on the edge block is carried out not only for each frame but also for each slice.

The LMB motion prediction and compensation unit 75 performs the motion compensation on the basis of the prediction mode information supplied from the lossless decoding unit 52 and the edge block determination result and generates the prediction image data to be output to the selector 76. That is, the LMB motion prediction and compensation 73 performs the motion compensation on the reference image indicated by the reference frame information at the motion vector based on the motion vector information on the basis of the motion vector information and the reference frame information included in the prediction mode information to generate the prediction image data. Also, the LMB motion prediction and compensation unit 75 performs the generation of the prediction image data in accordance with the macro block type set while corresponding to the edge block.

The selector 76 supplies the prediction image data generated in the AVC intra prediction unit 71, the LMB intra prediction unit 72, the AVC motion prediction and compensation unit 73, and the LMB motion prediction and compensation unit 75 to the addition unit 55.

<6. Configuration of LMB Motion Prediction and Compensation Unit>

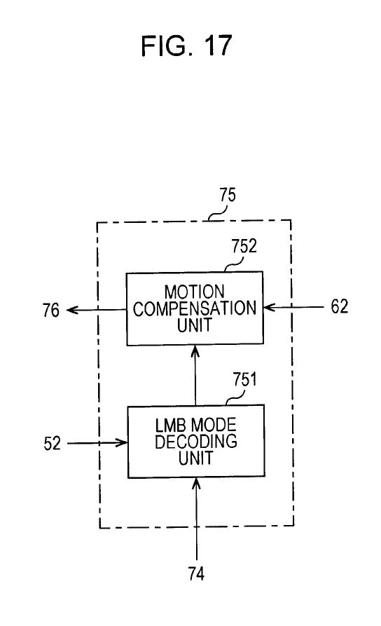

FIG. 17 illustrates a configuration of the LMB motion prediction and compensation unit 75. The LMB motion prediction and compensation unit 75 has an LMB mode decoding unit 751 and a motion compensation unit 752.

The LMB mode decoding unit 751 determines the prediction block size on the basis of the information indicating the macro block type included in the prediction mode information supplied from the lossless decoding unit 52 and the edge block determination result from the edge LMB determination unit 74. As described above, the lossless coding unit 16 of the image coding apparatus 10 generates the coding stream without changing the syntax element irrespective of whether or not the block is the edge block. Therefore, the LMB mode decoding unit 751 switches semantics that are meanings of the syntax element on the basis of the edge block determination result from the edge LMB determination unit 74. To be specific, when the edge block determination result indicates that the block is the edge block, as the semantics, the prediction block sizes corresponding to mb64_type and mb32_type illustrated in FIGS. 6, 8, and 9 are used. Also, when the edge block determination result indicates that it is not the edge block, as the semantics, the prediction block sizes corresponding to mb64_type and mb32_type illustrated in FIG. 3 are used. It should be noted that to determine which one of FIGS. 6, 8, and 9 is used, the edge LMB determination unit 74 may determine the number of pixels fewer than the macro block by using, for example, the numbers of pixels in the horizontal direction and the vertical direction of the image of the coding target and address information on the sequentially set macro blocks. The edge LMB determination unit 74 can determine which one of FIGS. 6, 8, and 9 is used on the basis of this determined number of pixels fewer than the macro block and the information indicating the macro block size.

Also, the LMB mode decoding unit 751 outputs the motion vector information and the reference frame information included in the prediction mode information supplied from the lossless decoding unit 52 to the motion compensation unit 752.

The motion compensation unit 752 performs the motion compensation by using the reference image data indicated by the reference frame information on the basis of the motion vector indicated by the motion vector information and the prediction block size determined by the LMB mode decoding unit 751. It should be noted that the reference image data uses the image data on the reference frame stored in the frame memory 61. The motion compensation unit 752 outputs the generated prediction image data to the selector 76.

<7. Operation of Image Decoding Apparatus>

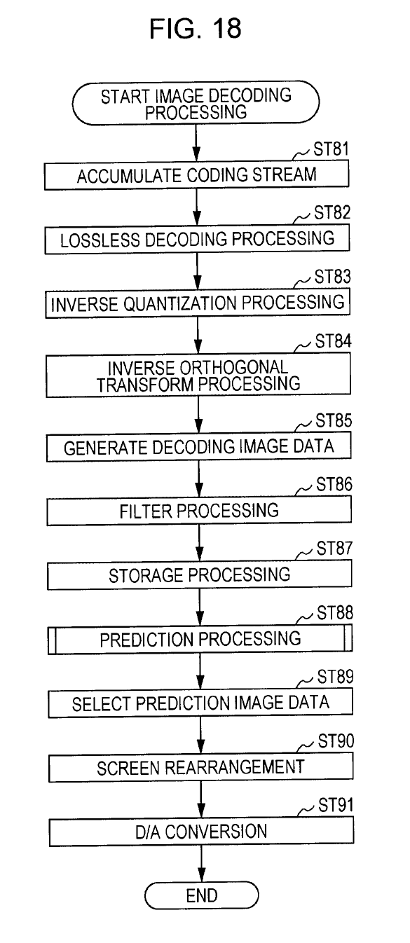

Next, with reference to a flow chart of FIG. 18, the image decoding processing operation performed in the image decoding apparatus 50 will be described.

In step ST81, the accumulation buffer 51 accumulates the transmitted coding stream. In step ST82, the lossless decoding unit 52 performs the lossless decoding processing. The lossless decoding unit 52 decodes the coding stream supplied from the accumulation buffer 51. That is, the quantization data on the respective pictures coded by the lossless coding unit 16 of FIG. 1 is obtained. Also, the lossless decoding unit 52 performs the lossless decoding on the prediction mode information included in the header information of the coding stream and supplies the obtained prediction mode information to the deblocking filter 56 and the selectors 62 and 76. Furthermore, in a case where the prediction mode information is information related to the intra prediction mode, the lossless decoding unit 52 outputs the prediction mode information to the AVC intra prediction unit 71 and the LMB intra prediction unit 72. Also, in a case where the prediction mode information is information related to the inter prediction mode, the lossless decoding unit 52 outputs the prediction mode information to the AVC motion prediction and compensation unit 73 and the LMB motion prediction and compensation unit 75.

In step ST83, the inverse quantization unit 53 performs the inverse quantization processing. The inverse quantization unit 53 subjects the quantization data decoded by the lossless decoding unit 52 to the inverse quantization in a characteristic corresponding to the characteristic of the quantization unit 15 of FIG. 1.

In step ST84, the inverse orthogonal transform unit 54 performs the inverse orthogonal transform processing. The inverse orthogonal transform unit 54 subjects the transform coefficient data inversely quantized by the inverse quantization unit 53 to the inverse orthogonal transform in a characteristic corresponding to the characteristic of the orthogonal transform unit 14 of FIG. 1.

In step ST85, the addition unit 55 performs the generation of the decoding image data. The addition unit 55 adds the data obtained by performing the inverse orthogonal transform processing to the prediction image data selected in step ST89 which will be described below to generate the decoding image data. According to this, the original image is decoded.

In step ST86, the deblocking filter 56 performs the filter processing. The deblocking filter 56 performs the filter processing on the decoding image data output by the addition unit 55 to remove the block distortion included in the decoding image.

In step ST87, the frame memory 61 stores the decoding image data.

In step ST88, the AVC intra prediction unit 71, the LMB intra prediction unit 72, the AVC motion prediction and compensation unit 73, and the LMB motion prediction and compensation unit 75 perform the prediction processing on the respective images while corresponding to the prediction mode information supplied from the lossless decoding unit 52.

That is, in a case where the intra prediction mode information is supplied from the lossless decoding unit 52, the AVC intra prediction unit 71 and the LMB intra prediction unit 72 perform the intra prediction processing in the intra prediction mode to generate the prediction image data. Also, in a case where the inter prediction mode information is supplied from the lossless decoding unit 52, the AVC motion prediction and compensation unit 73 and the LMB motion prediction and compensation unit 75 perform the motion prediction and compensation processing in the inter prediction mode to generate the prediction image data.

In step ST89, the selector 76 performs the selection of the prediction image data. That is, the selector 76 supplies the prediction image data generated in the AVC intra prediction unit 71, the LMB intra prediction unit 72, the AVC motion prediction and compensation unit 73, and the LMB motion prediction and compensation unit 75 to the addition unit 55 to be added to the output of the inverse orthogonal transform unit 54 as described above to generate the decoding image data.

In step ST90, the screen rearrangement buffer 57 performs the image rearrangement. That is, the screen rearrangement buffer 57 rearranges the order of the frames rearranged for the coding by the screen rearrangement buffer 12 in the image coding apparatus 10 of FIG. 1 into the original display order.

In step ST91, the D/A conversion unit 58 subjects the image data from the screen rearrangement buffer 57 to the D/A conversion. This image is output to a display that is not illustrated in the drawing, and the image is displayed.

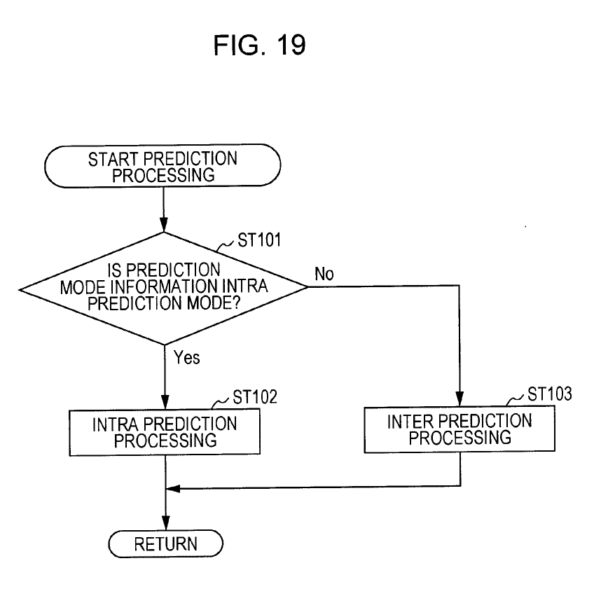

Next, with reference to a flow chart of FIG. 19, the prediction processing in step ST88 of FIG. 18 will be described.

In step ST101, the lossless decoding unit 52 determines whether or not the target block is subjected to the intra coding. In a case where the prediction mode information obtained by performing the lossless decoding is the intra prediction mode information, the lossless decoding unit 52 supplies the prediction mode information to the AVC intra prediction unit 71 and the LMB intra prediction unit 72 and advances to step ST102. Also, in a case where the prediction mode information is not the intra prediction mode information, the lossless decoding unit 52 supplies the prediction mode information to the AVC motion prediction and compensation unit 73 and the LMB motion prediction and compensation unit 75 and advances to step ST103. Also, the lossless decoding unit 52 may utilize the information on the macro block size included in the prediction mode information and supply the prediction mode information to the corresponding AVC intra prediction unit 71, the LMB intra prediction unit 72, the AVC motion prediction and compensation unit 73, or the LMB motion prediction and compensation unit 75. Also, the prediction mode information may be supplied to the AVC intra prediction unit 71, the LMB intra prediction unit 72, the AVC motion prediction and compensation unit 73, and the LMB motion prediction and compensation unit 75 to determine whether the prediction mode information is the corresponding information in the respective units.

In step ST102, the AVC intra prediction unit 71 or the LMB intra prediction unit 72 performs the intra prediction processing. In a case where the macro block indicated by the prediction mode information is the size prescribed in H.264/AVC, the AVC intra prediction unit 71 performs the intra prediction by using the decoding image data and the prediction mode information supplied via the selector 62 to generate the prediction image data. Also, the AVC intra prediction unit 71 outputs the generated prediction image data to the selector 76. In a case where the macro block indicated by the prediction mode information is a size larger than the size prescribed in H.264/AVC, the LMB intra prediction unit 72 performs the intra prediction by using the decoding image data and the prediction mode information supplied via the selector 62 to generate the prediction image data. Also, the LMB intra prediction unit 72 outputs the generated prediction image data to the selector 76.

In step ST103, the AVC motion prediction and compensation unit 73 or the LMB motion prediction and compensation unit 75 performs the inter prediction processing. In a case where the macro block indicated by the prediction mode information is the size prescribed in H.264/AVC, the AVC motion prediction and compensation unit 73 uses the motion vector information and the reference frame information indicated by the prediction mode information, the information on the macro block type, and the like to perform the motion compensation on the decoding image data supplied via the selector 62. Furthermore, the AVC motion prediction and compensation unit 73 outputs the prediction image data generated by the motion compensation to the selector 76. In a case where the macro block indicated by the prediction mode information is a size larger than the size prescribed in H.264/AVC, the LMB motion prediction and compensation unit 75 uses the motion vector information and the reference frame information indicated by the prediction mode information, the edge determination result, the information on the macro block type, and the like to perform the motion compensation on the decoding image data supplied via the selector 62. Furthermore, the LMB motion prediction and compensation unit 75 outputs the prediction image data generated by the motion compensation to the selector 76.

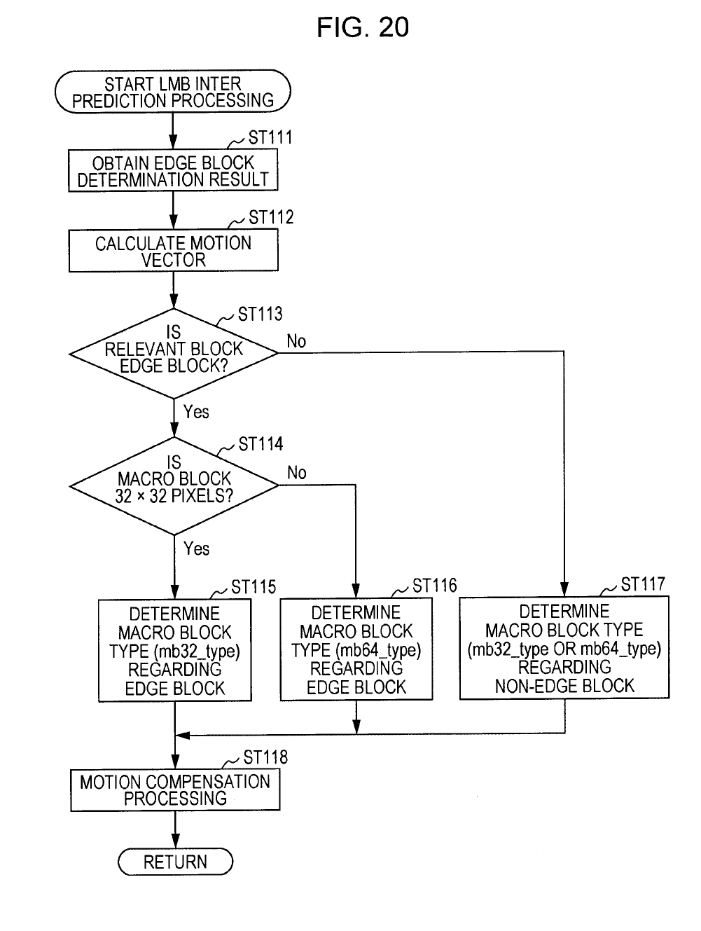

Also, the inter prediction processing performed in the LMB motion prediction and compensation unit 75 in step ST103 of FIG. 19 will be described by using a flow chart of FIG. 20.

In step ST111, the LMB motion prediction and compensation unit 75 obtains the prediction mode information and the edge block determination result on the relevant block. The LMB motion prediction and compensation unit 75 obtains the prediction mode information from the lossless decoding unit 52. Also, the LMB motion prediction and compensation unit 75 obtains the edge block determination result on the relevant block from the edge LMB determination unit 74 and advances to step ST112.

In step ST112, the LMB motion prediction and compensation unit 75 calculates a motion vector. The LMB motion prediction and compensation unit 75 calculates the motion vector with respect to the relevant block from the motion vector information and the prediction vector included in the prediction mode information and advances to step ST113.

In step ST113, the LMB motion prediction and compensation unit 75 determines whether or not the relevant block is the edge block. The LMB motion prediction and compensation unit 75 advances to step ST114 when the determination result indicates the edge block and advances to step ST117 when the determination result does not indicate the edge block.

In step ST114, the LMB motion prediction and compensation unit 75 determines whether or not the edge block is the edge block (edge LMB32) at a time when the macro block is set as 32×32 pixels. In a case where it is determined that the macro block is set as 32×32 pixels on the basis of the information indicating the macro block size included in the prediction mode information, since the edge block is the edge block (edge LMB32), the LMB motion prediction and compensation unit 75 advances to step ST115. Also, in a case where it is determined that the macro block is set as 64×64 pixels, since the edge block is the edge block (edge LMB64) at a time when the macro block is set as 64×64 pixels, and the LMB motion prediction and compensation unit 75 advances to step ST116.

In step ST115, the LMB motion prediction and compensation unit 75 performs the determination on the macro block type mb32_type included in the prediction mode information with regard to the edge block. That is, the LMB motion prediction and compensation unit 75 determines the prediction block size corresponding to the macro block type mb32_type on the basis of the semantics of FIG. 6 and advances to step ST118.

In step ST116, the LMB motion prediction and compensation unit 75 performs the determination on the macro block type mb64_type included in the prediction mode information with regard to the edge block. That is, the LMB motion prediction and compensation unit 75 determines the prediction block size corresponding to the macro block type mb64_type in accordance with the size of the edge block on the basis of the semantics of FIG. 8 or FIG. 9 and advances to step ST118.

In step ST117, the LMB motion prediction and compensation unit 75 determines the macro block type mb32_type or mb64_type. That is, the LMB motion prediction and compensation unit 75 determines the prediction block size corresponding to the macro block type mb32_type, mb64_type on the basis of the semantics of FIG. 3 and advances to step ST118.

In step ST118, the LMB motion prediction and compensation unit 75 performs the motion compensation and generates the prediction image data. The LMB motion prediction and compensation unit 75 performs the motion compensation on the basis of the determined prediction block size, the motion vector, and the reference frame by using the decoding image data supplied from the selector 62 and generates the prediction image data.

That is, in a case where the edge LMB determination unit 74 determines the edge block, on the basis of the macro block type information obtained through the decoding processing on the image data, the LMB motion prediction and compensation unit 75 determines whether the prediction block size is the region determined as the edge block or the size of the region obtained by dividing the region determined as the edge block in one of directions of the horizontal direction and the vertical direction with respect to the region determined as the edge block. The LMB motion prediction and compensation unit 75 generates the prediction image data used for the decoding processing on the image data at this determined prediction block size. Also, in a case where the edge block determined by the edge LMB determination unit 74 is a square region, on the basis of the macro block type information obtained through the decoding processing on the image data, the MB motion prediction and compensation unit 75 determines whether the prediction block size is one of the prediction block sizes set for the macro blocks at a lower level having a size smaller than the macro block with respect to the square region determined as the edge block and generates the prediction image data at this determined prediction block size.

In this manner, according to the image decoding apparatus and method of the invention of the present application, in a case where the edge block having the size smaller than the block on which the decoding processing is carried out is generated in the edge part of the coding target image, while the region determined as the edge block is set as a target, even when the prediction block size at which the coding efficiency is increased is set in the image coding apparatus by using the prediction block size corresponding to the size of the region determined as the edge block and the prediction block size corresponding to the size of the plural non-square regions obtained by dividing the region determined as the edge block in one of the directions of the horizontal direction and the vertical direction, it is possible to generate the prediction image data from which the image with this set prediction block size is predicted. Therefore, by performing the image decoding processing by using the generated prediction image data, it is possible to correctly carry out the decoding processing on the coding stream.

Also, when the prediction block size according to the edge block is used, even when the coding stream is generated without changing the syntax element by the image coding apparatus, the image decoding apparatus can perform the switching to the semantics in accordance to the edge block by using the determination result on the edge block or the like. Therefore, it is possible to correctly determine the prediction block size in accordance to the edge block on the basis of the macro block type information. For this reason, it is not necessary to transmit the syntax element indicating the prediction block size of the edge block from the image coding apparatus to the image decoding apparatus, and the increase in the data amount of the coding stream is does not incur.

Also, according to the above-mentioned mode, the case has been described in which the switching of the semantics is performed by using the edge block determination result and the motion compensation and the generation of the prediction image are carried out at the prediction block size according to the edge block in the LMB motion prediction and compensation units 35 and 75. However, the prediction processing using the prediction block size according to the edge block is not limited to the inter prediction processing. For example, the switching of the semantics may be performed by using the edge block determination result, and in the LMB intra prediction units 32 and 72, the prediction may be carried out at the prediction block size according to the edge block.

Furthermore, the series of processings described in the specification can be executed by hardware or software, or a composite configuration of the both. In a case where the processing based on the software is executed, a program recording a processing sequence is installed into a memory in a computer incorporated in dedicated-use hardware for execution. Alternatively, it is also possible to install the program into a general-use personal computer that can execute various processings for execution.

For example, the program can be previously recorded in a hard disc or a ROM (Read Only Memory) functioning as a recording medium. Alternatively, the program can be temporarily or enduringly stored (recorded) in a removable recording medium such as a flexible disc, a CD-ROM (Compact Disc Read Only Memory), an MO (Magneto optical) disc, a DVD (Digital Versatile Disc), a magnetic disc, or a semiconductor memory. The above-mentioned removable recording medium can be provided as so-called package software.

It should be noted that the program can be installed from the above-mentioned removable recording medium into a computer. In addition, the program can be wirelessly transferred from a download site to the computer or transferred in a wired manner via a network such as LAN (Local Area Network) or the internet to the computer, and the computer can receive the thus transferred program to be installed into the recording medium such as the built-in hard disc.

Furthermore, the present invention should not be construed while being limited to the above-mentioned embodiments of the invention. According to the embodiments of this invention, the present invention is disclosed by way of exemplifications, and it is obvious that those skilled in the art may devise modifications and alterations of the embodiments without departing from the gist of the present invention. That is, to determine the gist of the present invention, a consideration should be given of the scope of claims.

### INDUSTRIAL APPLICABILITY

According to the image coding apparatus and the image coding method, and the image decoding apparatus and the image decoding method of this invention, with regard to the edge block having a size smaller than the block size of the block on which the coding processing or the decoding processing is carried out, the coding efficiency is determined at the prediction block size corresponding to the size of the region determined as the edge block and the prediction block size corresponding to the size of the plural non-square regions obtained by dividing the region determined as the edge block in one of the directions of the horizontal direction and the vertical direction, and the coding and the decoding of the image are carried out at the prediction block size at which the coding efficiency is increased. For this reason, the prediction block size of the macro block at the lower level having the small size is used with respect to the edge block, and the division of the edge block into a large number of blocks to be coded is avoided, so that the data amount of the coding data can be reduced by using a larger block. Therefore, as in MPEG, H.26x, and the like, the technology is suitable to the image coding apparatus, the image decoding apparatus, and the like which are used when the image information (bit stream) obtained by performing the coding in units of the block is transmitted and received via satellite broadcasting, cable TV, the internet, and network media such as mobile phones or when the image information is processed on storage media such as an optical or magnetic disc and a flash memory.

### REFERENCE SIGNS LIST

10 IMAGE CODING APPARATUS
11 A/D CONVERSION UNIT
12, 57 SCREEN REARRANGEMENT BUFFER
13 SUBTRACTION UNIT
14 ORTHOGONAL TRANSFORM UNIT
15 QUANTIZATION UNIT
16 LOSSLESS CODING UNIT
17, 51 ACCUMULATION BUFFER
18 RATE CONTROL UNIT
21, 53 INVERSE QUANTIZATION UNIT
22, 54 INVERSE ORTHOGONAL TRANSFORM UNIT
23, 55 ADDITION UNIT
24, 56 DEBLOCKING FILTER
25, 61 FRAME MEMORY
26, 62, 76 SELECTOR
31, 71 AVC INTRA PREDICTION UNIT
32, 72 LMB INTRA PREDICTION UNIT
33, 73 AVC MOTION PREDICTION AND COMPENSATION UNIT
34, 74 EDGE LMB DETERMINATION UNIT
35, 75 LMB MOTION PREDICTION AND COMPENSATION UNIT
36 PREDICTION IMAGE AND OPTIMAL MODE SELECTION UNIT
50 IMAGE DECODING APPARATUS
52 LOSSLESS DECODING UNIT
58 D/A CONVERSION UNIT
351 MOTION SEARCH UNIT
352 COST FUNCTION VALUE CALCULATION UNIT
353 MODE DETERMINATION UNIT
354 MOTION COMPENSATION UNIT
751 LMB MODE DECODING UNIT
752 MOTION COMPENSATION UNIT

1-13. (canceled)

14. An image coding apparatus that performs a coding processing on image data, the apparatus comprising:
an edge block determination unit configured to determine, in a case where a block is set with respect to an image of a coding target, an edge block having a size smaller than a block size of the block;
a prediction processing unit configured to detect, while a region determined as the edge block by the edge block determination unit is set as a target, a prediction block size corresponding to a size of the region determined as the edge block or a prediction block size corresponding to a size of plural non-square regions obtained by dividing the region determined as the edge block in one of directions of a horizontal direction and a vertical direction; and
a coding unit configured to code the image data and prediction mode information related to the prediction processing on the prediction block size detected by the prediction processing unit to generate a coding stream.

15. The image coding apparatus according to claim 14,
wherein the prediction processing unit determines a coding efficiency at the prediction block size corresponding to the size of the region determined as the edge block or the prediction block size corresponding to the size of the plural non-square regions obtained by dividing the region determined as the edge block in one of the directions of the horizontal direction and the vertical direction and detects the prediction block size at which the coding efficiency is increased.

16. The image coding apparatus according to claim 15,
wherein the prediction processing unit determines coding efficiencies at respective prediction block sizes while a square region determined as the edge block and a square region generated after the division are set as targets by using a prediction block size set with respect to a block at a lower level having a size smaller than the block.

17. The image coding apparatus according to claim 16,
wherein the prediction processing unit uses the prediction block size corresponding to the size of the region determined as the edge block or the prediction block size corresponding to the size of the plural non-square regions obtained by dividing the region determined as the edge block in one of the directions of the horizontal direction and the vertical direction in a case where the block is larger than a predetermined size.

18. The image coding apparatus according to claim 17,
wherein the edge block determination unit performs the determination on the edge block for each frame or each slice.

19. The image coding apparatus according to claim 14, further comprising:
a setting unit configured to set semantics of a syntax element to match a correspondence relationship between a block type indicating a coding type of the block and the prediction block size with the block and the edge block determined by the edge block determination unit.

20. The image coding apparatus according to claim 19,
wherein the coding unit holds the syntax element depending on whether or not the block is the edge block and generates the coding stream.

21. An image coding method of performing a coding processing on image data, the method comprising the steps of:
determining, in a case where a block is set with respect to an image of a coding target, an edge block having a size smaller than a block size of the block;
detecting, while a region determined as the edge block is set as a target, a prediction block size corresponding to a size of the region determined as the edge block or a prediction block size corresponding to a size of plural non-square regions obtained by dividing the region determined as the edge block in one of the directions of the horizontal direction and the vertical direction; and
coding the image data and prediction mode information related to the prediction processing on the detected prediction block size and generating a coding stream.

22. An image decoding apparatus that performs a decoding processing on a coding stream obtained by coding image data, the apparatus comprising:
an edge block determination unit configured to determine, on the basis of an image size of a decoding target image and a position of a block on which the decoding processing is performed, an edge block having a size smaller than a block size of the block;
a prediction processing unit configured to generate prediction image data used for the decoding processing on the image data at a prediction block size corresponding to a size of a region determined as the edge block or a region obtained by dividing the region determined as the edge block in one of directions of a horizontal direction and a vertical direction while a non-square region determined as the edge block is set as a target in a case where the edge block is determined by the edge block determination unit; and
a decoding unit configured to decode the coding stream by using the prediction image data generated by the prediction processing unit.

23. The image decoding apparatus according to claim 22,
wherein the prediction processing unit determines whether the prediction block size is a size of the region determined as the edge block or a region obtained by dividing the region determined as the edge block in one of directions of a horizontal direction and a vertical direction on the basis of block type information obtained through the decoding processing on the image data and generates the prediction image data at the determined prediction block size.

24. The image decoding apparatus according to claim 23,
wherein the prediction processing unit determines whether the prediction block size is one of prediction block sizes set with respect to macro blocks at a lower level having a size smaller than the macro block while a square region determined as the edge block is set as a target on the basis of block type information obtained through the decoding processing on the image data in a case where the edge block determined by the edge block determination unit is a square region and generates the prediction image data used for the decoding processing on the image data at the determined prediction block size.

25. The image coding apparatus according to claim 22,
wherein the coding stream is generated in a state in which semantics of a syntax element are set to match a correspondence relationship between a block type indicating a coding type of the block and the prediction block size with the block and the edge block while the syntax element is held.

26. The image decoding apparatus according to claim 24,
wherein the prediction processing unit determines the prediction block sizes in the block and the edge block by switching semantics of a syntax element indicating the prediction block size included in the coding stream in accordance with the determination result of the edge block determination unit.

27. The image decoding apparatus according to claim 26,
wherein the edge block determination unit performs the determination on the edge block having a size smaller than the block size of the block for each frame or each slice.

28. An image decoding method of performing a decoding processing on a coding stream obtained by coding image data, the method comprising the steps of:
determining, on the basis of an image size of a decoding target image and a position of a block on which the decoding processing is performed, an edge block having a size smaller than a block size of the block;
generating prediction image data used for the decoding processing on the image data at a prediction block size corresponding to a size of a region determined as the edge block or a region obtained by dividing the region determined as the edge block in one of directions of a horizontal direction and a vertical direction while a non-square region determined as the edge block is set as a target in a case where the edge block is determined; and
decoding the coding stream by using the generated prediction image data.
